(19) United States
(12) Patent Application Publication
(10) Pub. No.: US 2009/0078365 A1
(43) Pub. Date: Mar. 26, 2009

(54) APPARATUS FOR AND METHOD OF MANUFACTURING PHOTOSENSITIVE LAMINATED BODY

(75) Inventors: Kazuyoshi Suehara, Shizuoka-ken (JP); Nobuyasu Akiyoshi, Shizuoka-ken (JP); Kenichi Imoto, Shizuoka-ken (JP); Ryoichi Sugihara, Shizuoka-ken (JP); Ryo Mori, Shizuoka-ken (JP); Chiaki Suzuki, Kanagawa-ken (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM CORPORATION, Minato-ku, Tokyo (JP)

(21) Appl. No.: 11/909,558

(22) PCT Filed: Jan. 5, 2006
(86) PCT No.: PCT/JP2006/300238

§ 371 Date: Sep. 24, 2007

(30) Foreign Application Priority Data
Mar. 23, 2005 (JP) 2005-084408
Jun. 30, 2005 (JP) 2005-192019

(51) Int. Cl. B32B 37/06

(52) U.S. Cl. 156/249; 156/498; 156/494; 156/499

(57) ABSTRACT

A manufacturing apparatus has a reel-out mechanism, a processing mechanism, a label bonding mechanism, a reservoir mechanism, a peeling mechanism, a substrate feed mechanism, an attachment mechanism, and a base peeling mechanism. A cooling mechanism is disposed between the attachment mechanism and the base peeling mechanism, for cooling an attached substrate, the attached substrate being made up of a glass substrate and a photosensitive web attached thereto, from which a protective film has been peeled off, together with a heating mechanism for heating a resin layer, for example a cushion layer, inside the cooled attached substrate to within a predetermined temperature range, which is at or below the glass transition temperature.

### TECHNICAL FIELD

The present invention relates to an apparatus for and a method of manufacturing a photosensitive laminated body comprising an elongate photosensitive web including a photosensitive material layer and a protective film that are successively deposited on a support, the protective film being peeled off every predetermined length, and the photosensitive material layer exposed by peeling off the protective film being attached to a substrate.

### BACKGROUND ART

Substrates for liquid crystal panels, substrates for printed wiring boards, and substrates for PDP panels, for example, have a photosensitive sheet (photosensitive web) having a photosensitive material (photosensitive resin) layer and applied to a substrate surface. The photosensitive sheet comprises a photosensitive material layer and a protective film that are successively deposited on a flexible plastic support.

An applying apparatus for applying such a photosensitive sheet usually operates to feed substrates such as glass substrates, resin substrates, or the like at predetermined intervals, and peel off the protective film from the photosensitive sheet for a length corresponding to the range of the photosensitive material layer that is to be applied to each of the substrates.

According to a method of and an apparatus for applying a film as disclosed in Japanese Laid-Open Patent Publication No. 11-34280, for example, as shown in FIG. 46 of the accompanying drawings, a laminated film 1a unreeled from a film roll 1 is trained around guide rolls 2a, 2b and extends along a horizontal film feed plane. The guide roll 2b is combined with a rotary encoder 3 for outputting as many pulses as depending on the length by which the laminated film 1a is fed.

The laminated film 1a that extends along the horizontal film feed plane from the guide rolls 2a, 2b is trained around a suction roll 4. A partial cutter 5 and a cover film peeler 6 are disposed along the horizontal film feed plane between the guide roll 2b and the suction roll 4.

The partial cutter 5 has a pair of disk cutters 5a, 5b. The disk cutters 5a, 5b are movable transversely across the laminated film 1a to cut off a cover film (not shown) of the laminated film 1a together with a photosensitive resin layer (not shown) on the reverse side of the cover film.

The cover film peeler 6 presses a sticky tape 7a unreeled from a sticky tape roll 7 strongly against the cover film between presser rollers 8a, 8b, and then winds up the sticky tape 7a around a takeup roll 9. The cover film is peeled off from the photosensitive resin layer by the sticky tape 7a, and wound together with the sticky tape 7a around the takeup roll 9.

The suction roll 4 is followed downstream by a pair of lamination rolls 12a, 12b for superposing and pressing the laminated film 1a against upper surfaces of a plurality of substrates 11 which are successively intermittently fed by a substrate feeder 10. A support film takeup roll 13 is disposed downstream of the lamination rolls 12a, 12b. Light-transmissive support films (not shown) applied to the respective substrates 11 are peeled off and wound up by the support film takeup roll 13.

In the above conventional art, measuring the number of pulses generated by the rotary encoder 3 is started when the partial cutter 5 starts cutting the laminated film 1a. When the measured value of the pulses: from the rotary encoder 3 reaches the value corresponding to the predetermined position to be cut on the laminated film 1a, the substrate feeder 10 is actuated. Thus, the substrates 11 are fed synchronously with the laminated film 1a between the lamination rolls 12a, 12b. In this way, the laminated film 1a is positioned for being applied to each of the substrates 11.

In the conventional art, measuring the number of pulses generated by the rotary encoder 3 on the guide roll 2b is started when the partial cutter 5 starts cutting. The substrates 11 are fed such that the partly cut region is considered to reach a predetermined position between the lamination rolls 12a, 12b, based on the measured value.

In this case, however, the length between the partial cutter 5 and the lamination rolls 12a, 12b is considerably large. Thus, the length of the laminated film 1a may vary due to the heat from lamination units, or the rotary encoder 3 may suffer from slippage. Thus, it is impossible to accurately position the laminated film 1a and the substrates 11 with respect to the lamination rolls 12a, 12b.

### DISCLOSURE OF INVENTION

It is a major object of the present invention to provide an apparatus for and a method of manufacturing a high-quality photosensitive laminated body, by accurately attaching an elongate photosensitive web to substrates through a simple process and arrangement.

According to the present invention, there is provided an apparatus for manufacturing a photosensitive laminated body, comprising: a web reel-out mechanism for reeling out an elongate photosensitive web comprising a support, a photosensitive material layer disposed on the support, and a protective film disposed on the photosensitive material layer, the protective film having a peel-off section and a residual section; a processing mechanism for forming a processed region which is transversely severable in the protective film of the elongate photosensitive web which has been reeled out by the web reel-out mechanism, at a boundary position between the peel-off section and the residual section; a peeling mechanism for peeling the peel-off section off from the elongate photosensitive web, leaving the residual section; a substrate feed mechanism for feeding a substrate which has been heated to a predetermined temperature to an attachment position; an attachment mechanism for positioning the residual section between the substrates and attaching an exposed area of the photosensitive material layer from which the peel-off section has been peeled off to the substrate in the attachment position, thereby producing an attached substrate; a support peeling mechanism positioned downstream from the attachment mechanism for peeling off the support from the attached substrate; a cooling mechanism positioned between the attachment mechanism and the support peeling mechanism, for cooling the attached substrate; and a heating mechanism for heating a resin layer, which is laminated on the support, within a predetermined temperature range which is at or below the glass transition temperature.

Further, the support peeling mechanism may preferably comprise a tension applying structure for applying tension to the support along the attachment direction with the substrate when peeling off the support.

Furthermore, the support peeling mechanism may preferably comprise a peeling roller for peeling the support from the substrate following an outer circumferential portion thereof, and a peeling guide member for guiding the support along an outer circumference of the peeling roller while moving between the substrates.

Still further, the attachment mechanism may preferably comprise: a pair of rubber rollers which are heated to a predetermined temperature; and a pair of backup rollers in sliding contact with the pair of rubber rollers, wherein outer circumferential surfaces of at least one of the rubber rollers and/or at least one of the backup rollers is set with a crown shape.

Further, according to the present invention, there is provided an apparatus for manufacturing a photosensitive laminated body, comprising: a web reel-out mechanism for reeling out an elongate photosensitive web comprising a support, a photosensitive material layer disposed on the support, and a protective film disposed on the photosensitive material layer, the protective film having a peel-off section and a residual section; a processing mechanism for forming a partially cut region which is transversely severable in the protective film of the elongate photosensitive web which has been reeled out by the web reel-out mechanism, at a boundary position between the peel-off section and the residual section; a peeling mechanism for peeling the peel-off section off from the elongate photosensitive web, leaving the residual section; a substrate feed mechanism for feeding a substrate which has been heated to a predetermined temperature to an attachment position; an attachment mechanism for positioning the residual section between the substrates and attaching an exposed area of the photosensitive material layer from which the peel-off section has been peeled off to the substrate in the attachment position, thereby producing an attached substrate; and a support peeling mechanism positioned downstream from the attachment mechanism for peeling off the support from the attached substrate, wherein the processing mechanism comprises: a cutter for forming the partially cut region in the elongate photosensitive web; and a heater for heating the partially cut region at the time of making the partial cut to a predetermined temperature corresponding to the cutter.

According to the present invention, there is also provided a method of manufacturing a photosensitive laminated body, comprising the steps of: reeling out an elongate photosensitive web each comprising a support, a photosensitive material layer disposed on the support, and a protective film disposed on the photosensitive material layer, the protective film having a peel-off section and a residual section; forming a processed region which is transversely severable in the protective film of the elongate photosensitive web which has been reeled out, at a boundary position between the peel-off section and the residual section; peeling the peel-off section off from the elongate photosensitive web, leaving the residual section; feeding a substrate which has been heated to a predetermined temperature to an attachment position; positioning the residual section between the substrates and attaching an exposed area of the photosensitive material layer from which the peel-off section has been peeled off to the substrate in the attachment position, thereby producing an attached substrate; cooling the attached substrate at a position downstream from the attachment position; and heating a resin layer, which is laminated on the support, within a predetermined temperature range which is at or below the glass transition temperature.

Further, the method may preferably comprise the steps of: peeling each support from the attached substrate and obtaining a photosensitive laminated body, after severing the elongate photosensitive web between the attached substrates downstream from the attachment position; and applying tension to the support along the attachment direction with the substrate when the support is peeled.

Furthermore, the method may preferably comprise the steps of: peeling the support from the substrate following an outer circumferential portion of a peeling roller; and guiding the support along an outer circumference of the peeling roller while a peeling guide member moves between the substrates.

In addition, according to the present invention, there is also provided a method of manufacturing a photosensitive laminated body, comprising the steps of: reeling out an elongate photosensitive web comprising a support, a photosensitive material layer disposed on the support, and a protective film disposed on the photosensitive material layer, the protective film having a peel-off section and a residual section; making a partial cut in the elongate photosensitive web while heating a partially cut region to a predetermined temperature corresponding to a cutter which is transversely severable in the protective film of the elongate photosensitive web which has been reeled out, at a boundary position between the peel-off section and the residual section; peeling the peel-off section off from the elongate photosensitive web, leaving the residual section; feeding a substrate which has been heated to a predetermined temperature to an attachment position; positioning the residual section between the substrates and attaching an exposed area of the photosensitive material layer from which the peel-off section has been peeled off to the substrate in the attachment position, thereby-producing an attached substrate; and preheating the elongate photosensitive web to a predetermined temperature at a vicinity upstream of the attachment position.

As a result of the above features, a photosensitive material layer can be transferred effectively onto a substrate, and a high-quality photosensitive laminated body can efficiently be produced. Further, in the elongate photosensitive web, residual stresses within the resin layer are reliably mitigated, and the support can be easily and favorably peeled off from the resin layer.

The above and other objects, features, and advantages of the present invention will become more apparent from the following description when taken in conjunction with the accompanying drawings in which preferred embodiments of the present invention are shown by way of illustrative example.

### BRIEF DESCRIPTION OF DRAWINGS

FIG. 1 is a schematic side elevational view of a manufacturing apparatus according to a first embodiment of the present invention;

FIG. 2 is an enlarged fragmentary cross-sectional view of an elongate photosensitive web used in the manufacturing apparatus;

FIG. 3 is a fragmentary plan view of the elongate photosensitive web with adhesive labels applied thereto;

FIG. 4 is a front elevational view of an attachment mechanism of the manufacturing apparatus;

FIG. 5 is a fragmentary cross-sectional view of a through region of the manufacturing apparatus;

FIG. 6 is a schematic view of a portion of the manufacturing apparatus, showing an initial state thereof;

FIG. 7 is a fragmentary side elevational view showing the manner in which a protective film is peeled off from the elongate photosensitive web;

FIG. 8 is a schematic view of a portion of the manufacturing apparatus, showing the manner in which a glass substrate enters between rubber rollers;

FIG. 9 is a schematic view of a portion of the manufacturing apparatus, showing the manner in which the rubber rollers start to rotate;

FIG. 10 is a schematic view of a portion of the manufacturing apparatus, showing its operation upon completion of a lamination process on a first glass substrate;

FIG. 11 is a schematic view of a portion of the manufacturing apparatus, showing the manner in which the rubber rollers and substrate feed rollers rotate;

FIG. 12 is a fragmentary cross-sectional view of glass substrates to which a photosensitive resin layer is transferred;

FIG. 13 is a schematic view of a portion of the manufacturing apparatus, showing the manner in which the substrate feed rollers are spaced from an end of an attached substrate;

FIG. 14 is a schematic view of a portion of the manufacturing apparatus, showing the manner in which elongate photosensitive webs are severed between attached substrates;

FIG. 15 is a schematic view of a portion of the manufacturing apparatus, showing a stopped state thereof;

FIG. 16 is a schematic view of a portion of the manufacturing apparatus, showing a finished state thereof;

FIG. 17 is a schematic view of a portion of the manufacturing apparatus, showing the manner in which the elongate photosensitive web has its leading end set in position;

FIG. 18 is a plan view showing the manner in which a photosensitive resin layer is advanced with respect to a glass substrate;

FIG. 19 is a plan view showing the manner in which a photosensitive resin layer is delayed with respect to a glass substrate;

FIG. 20 is a schematic side elevational view of a manufacturing apparatus according to a second embodiment of the present invention;

FIG. 21 is a plan view showing the manner in which a photosensitive resin layer having a prescribed length is applied to a glass substrate;

FIG. 22 is a plan view showing the manner in which a photosensitive resin layer longer than a prescribed length is applied to a glass substrate;

FIG. 23 is a plan view showing the manner in which a photosensitive resin layer shorter than a prescribed length is applied to a glass substrate;

FIG. 24 is a schematic side elevational view of a manufacturing apparatus according to a third embodiment of the present invention;

FIG. 25 is an enlarged cross-sectional view of a pre-peeler of the manufacturing apparatus according to the third embodiment;

FIG. 26 is an enlarged cross-sectional view showing the manner in which the pre-peeler operates;

FIG. 27 is a view illustrative of the manner in which the position of a photosensitive resin layer applied to a glass substrate is detected;

FIG. 28 is a schematic side elevational view of a manufacturing apparatus according to a fourth embodiment of the present invention;

FIG. 29 is a cross sectional view of an elongate photosensitive web used in the manufacturing apparatus;

FIG. 30 is a view showing characteristics between temperature and a tan δ;

FIG. 31 is a schematic perspective view illustrating a peeling mechanism forming a portion of the manufacturing apparatus;

FIG. 32 is a perspective view of an essential part of the peeling mechanism;

FIG. 33 is a view illustrating operation of the peeling mechanism;

FIG. 34 is a view indicating a relationship between a base film surface temperature and defects in film peeling;

FIG. 35 is a schematic perspective view of a base peeling mechanism, making up the manufacturing apparatus in accordance with a fifth embodiment of the present invention;

FIG. 36 is a schematic perspective view of a base peeling mechanism, making up the manufacturing apparatus in accordance with a sixth embodiment of the present invention;

FIG. 37 is a schematic perspective view of an automatic base peeling mechanism, making up the manufacturing apparatus in accordance with a seventh embodiment of the present invention;

FIG. 38 is a view illustrating operation of the automatic base peeling mechanism;

FIG. 39 is a view illustrating operation of the automatic base peeling mechanism;

FIG. 40 is a view illustrating operation of the automatic base peeling mechanism;

FIG. 41 is a view showing a peeling bar including a tapered portion;

FIG. 42 is a frontal view showing an attachment mechanism making up the manufacturing apparatus in accordance with an eighth embodiment of the present invention;

FIG. 43. is a view showing a crown roller, which forms a portion of the attachment mechanism;

FIG. 44 is a schematic perspective view of a processing mechanism making up the manufacturing apparatus in accordance with a ninth embodiment of the present invention;

FIG. 45 is a schematic side elevational view of the processing mechanism; and

FIG. 46 is a schematic side elevational view of a conventional film applying apparatus.

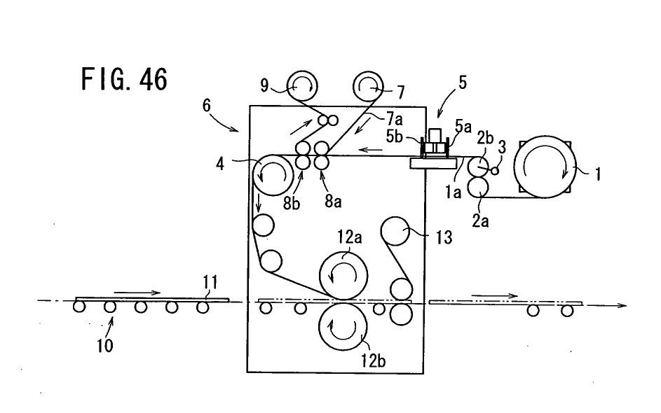

### BEST MODE FOR CARRYING OUT THE INVENTION

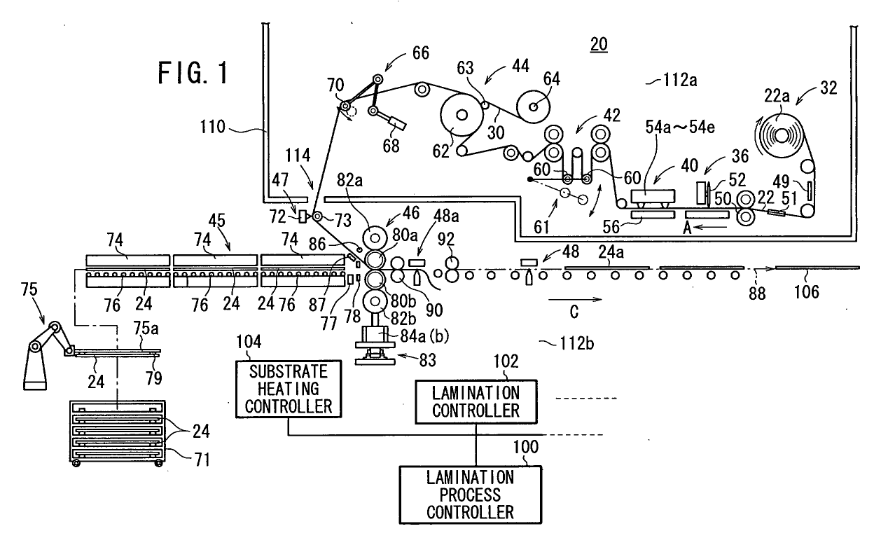

FIG. 1 shows in schematic side elevation an apparatus 20 for manufacturing a photosensitive laminated body according to a first embodiment of the present invention. The manufacturing apparatus 20 operates to thermally transfer a photosensitive resin layer 28 (described later) of an elongate photosensitive web 22 to glass substrates 24 in a process of manufacturing liquid crystal or organic EL color filters.

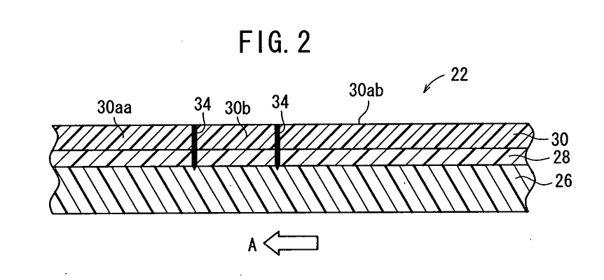

FIG. 2 shows in cross section the photosensitive web 22 that is employed in the manufacturing apparatus 20. The photosensitive web 22 comprises a laminated assembly of a flexible base film (support) 26, a photosensitive resin layer (photosensitive material layer) 28 disposed on the flexible base film 26, and a protective film 30 disposed on the photosensitive resin layer 28.

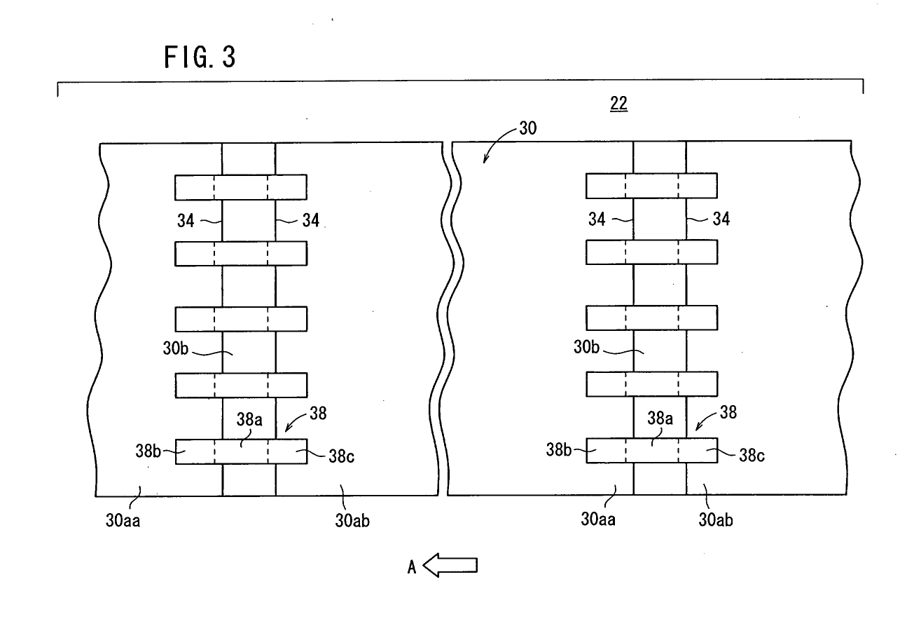

As shown in FIG. 1, the manufacturing apparatus 20 has a reel-out mechanism 32 for accommodating a photosensitive web roll 22a in the form of rolled photosensitive web 22 and reeling out the photosensitive web 22 from the photosensitive web roll 22a, a processing mechanism 36 for forming a partly cut region (a processed region) 34 which is located at a transversely severable boundary position in a protective film 30 of the photosensitive web 22 reeled out from the photosensitive web roll 22a, and a label bonding mechanism 40 for bonding adhesive labels 38 (see FIG. 3) each having a non-adhesion area 38a to the protective film 30.

The manufacturing apparatus 20 also has, positioned downstream of the label bonding mechanism 40, a reservoir mechanism 42 for changing the feed mode of the photosensitive web 22 from an intermittent feed mode to a continuous feed mode, a peeling mechanism 44 for peeling a predetermined length of the protective film 30 from the photosensitive web 22, a substrate feed mechanism 45 for feeding a glass substrate 24 which is heated to a predetermined temperature to an attachment position, and an attachment mechanism 46 for attaching the photosensitive resin layer 28 which has been exposed by peeling off the protective film 30 to the glass substrate 24.

A detecting mechanism 47 for directly detecting the partly cut region 34 at the boundary position of the photosensitive web 22 is disposed upstream of and closely to the attachment position in the attachment mechanism 46. An inter-substrate web cutting mechanism 48 for cutting the photosensitive web 22 between adjacent glass substrates 24 is disposed downstream of the attachment mechanism 46. A web cutting mechanism 48a that is used when the manufacturing apparatus 20 starts and finishes operating is disposed upstream of the inter-substrate web cutting mechanism 48.

An attachment base 49 for attaching the trailing end of photosensitive web 22 that has essentially been used up and the leading end of photosensitive web 22 that is to be newly used is disposed downstream or and closely to the reel-out mechanism 32. The attachment base 49 is followed downstream by a film end position detector 51 for controlling transverse shifts of the photosensitive web 22 due to winding irregularities of the photosensitive web roll 22a. The film end of the photosensitive web 22 is positionally adjusted by transversely moving the reel-out mechanism 32. However, the film end of the photosensitive web 22 may be adjusted by a position adjusting mechanism combined with rollers. The reel-out mechanism 32 may comprise a multi-shaft mechanism including two or three unreeling shafts for supporting the photosensitive web roll 22a and feeding out the photosensitive web 22.

The processing mechanism 36 is disposed downstream of respective roller pairs 50 for calculating the diameter of the photosensitive web roll 22a accommodated in the reel-out mechanism 32. The processing mechanism 36 has a single circular blade 52 which travels transversely across the photosensitive web 22 to form a partly cut region 34 in the photosensitive web 22 at a given position thereon.

As shown in FIG. 2, the partly cut region 34 needs to be formed in and across at least the protective film 30. Actually, the circular blade 52 is set to a cutting depth large enough to cut into the photosensitive resin layer 28 or the base film 26 in order to reliably cut off the protective film 30. The circular blade 52 may be fixed against rotation and moved transversely across the photosensitive web 22 to form the partly cut region 34, or may be rotated without slippage on the photosensitive web 22 and moved transversely across the photosensitive web 22 to form the partly cut region 34. The circular blade 52 may be replaced with a laser beam or ultrasonic cutter, a knife blade, or a pushing blade (Thompson blade), for example.

The processing mechanism 36 may comprise two processing mechanisms disposed at a predetermined interval in the direction indicated by the arrow A in which the photosensitive web 22 is fed, for simultaneously forming two partly cut regions 34 with a residual section 30b interposed therebetween.

Two closely spaced partly cut regions 34 formed in the protective film 30 serve to set a spaced interval between two adjacent glass substrates 24. For example, these partly cut regions 34 are formed in the protective film 30 at positions that are 10 mm spaced inwardly from respective edges of the glass substrates 24. The section of the protective film 30 which is interposed between the partly cut regions 34 and exposed between the glass substrates 24 functions as a mask when the photosensitive resin layer 28 is applied as a frame to the glass substrate 24 in the attachment mechanism 46 to be described later.

The label bonding mechanism 40 supplies adhesive labels 38 for interconnecting a front peel-off section 30aa and a rear peel-off section 30ab in order to leave a residual section 30b of the protective film 30 between glass substrates 24. As shown in FIG. 2, the front peel-off section 30aa which is to be peeled off initially and the rear peel-off section 30ab which is to be peeled off subsequently are positioned on respective both sides of the residual section 30b.

As shown in FIG. 3, each of the adhesive labels 38 is of a rectangular strip shape and is made of the same material as the protective film 30. Each of the adhesive labels 38 has a non-adhesion (or slightly adhesive) area 38a positioned centrally which is free of an adhesive, and a first adhesion area 38b and a second adhesion area 38c which are disposed respectively on the longitudinally opposite ends of the reverse side (adhesion side) of the non-adhesion area 38a, i.e., on the longitudinally opposite end portions of the adhesive label 38, the first adhesion area 38b and the second adhesion area 38c being bonded respectively to the front peel-off section 30aa and the rear peel-off section 30ab.

As shown in FIG. 1, the label bonding mechanism 40 has suction pads 54a through 54e for applying a maximum of five adhesive labels 38 at predetermined intervals. A support base 56 that is vertically movable for holding the photosensitive web 22 from below is disposed in a position where adhesive labels 38 are applied to the photosensitive web 22 by the suction pads 54a through 54e.

The reservoir mechanism 42 absorbs a speed difference between the intermittent feed mode in which the photosensitive web 22 is fed upstream of the reservoir mechanism 42 and the continuous feed mode in which the photosensitive web 22 is fed downstream of the reservoir mechanism 42. The reservoir mechanism 42 has a dancer roller unit 61 comprising two dancer rollers 60 which are rotatable and swingable for blocking variations of the tension. The dancer roller unit 61 may comprise only one roller or three or more rollers, depending on a desirable amount of reservoir of a web.

The peeling mechanism 44, which is disposed downstream of the reservoir mechanism 42, has a suction drum 62 for blocking variations of the tension to which the supplied photosensitive web 22 is subjected for thereby stabilizing the tension of the photosensitive web 22 when it is subsequently laminated. The peeling mechanism 44 also has a peeling roller 63 disposed closely to the suction drum 62. The protective film 30 that is peeled off from the photosensitive web 22 at a sharp peel-off angle is wound, except residual sections 30b, by a protective film takeup unit 64.

A tension control mechanism 66 for imparting tension to the photosensitive web 22 is disposed downstream of the peeling mechanism 44. The tension control mechanism 66 has a cylinder 68 that is actuatable to angularly displace a tension dancer 70 to adjust the tension of the photosensitive web 22 with which the tension dancer 70 is held in rolling contact. The tension control mechanism 66 may be employed only when necessary, and may be dispensed with.

The detecting mechanism 47 has a photoelectric sensor 72 such as a laser sensor, a photosensor, or the like for directly detecting changes in the photosensitive web 22 due to wedge-shaped grooves in the partly cut regions 34, steps produced by different thicknesses of the protective film 30, or a combination thereof. Detected signals from the photoelectric sensor 72 are used as boundary position signals representative of the boundary positions in the protective film 30. The photoelectric sensor 72 is disposed in confronting relation to a backup roller 73. Alternatively, a non-contact displacement gauge or image inspecting means such as a CCD camera or the like may be employed instead of the photoelectric sensor 72.

The positional data of the partly cut regions 34 which are detected by the detecting mechanism 47 can be statistically processed and converted into graphic data in real time. When the positional data detected by the detecting mechanism 47 show an undue variation or bias, the manufacturing apparatus 20 may generate a warning.

The manufacturing apparatus 20 may employ a different system for generating boundary position signals. According to such a different system, the partly cut regions 34 are not directly detected, but marks are applied to the photosensitive web 22. For example, holes or recesses may be formed in the photosensitive web 22 near the partly cut regions 34 in the vicinity of the processing mechanism 36, or the photosensitive web 22 may be slit by a laser beam or an aqua jet or may be marked by an ink jet or a printer. The marks on the photosensitive web 22 are detected, and detected signals are used as boundary position signals.

The substrate feed mechanism 45 has a plurality of substrate heating units (e.g., heaters) 74 disposed for sandwiching and heating glass substrates 24, and a feeder 76 for feeding glass substrates 24 in the direction indicated by the arrow C. The temperatures of the glass substrates 24 in the substrate heating units 74 are monitored at all times. When the monitored temperature of a glass substrate 24 becomes abnormal, the feeder 76 is inactivated and a warning is issued, and abnormality information is sent to reject and discharge the abnormal glass substrate 24 in a subsequent process, and is also used for quality control and production management. The feeder 76 has an air-floated plate (not shown) for floating and feeding glass substrates 24 in the direction indicated by the arrow C. Instead, the feeder 76 may comprise a roller conveyor for feeding glass substrates 24.

The temperatures of the glass substrates 24 should preferably be measured in the substrate heating units 74 or immediately prior to the attaching position according to a contact process (using a thermocouple, for example) or a non-contact process.

A substrate storage frame 71 for storing a plurality of glass substrates 24 is disposed upstream of the substrate heating unit 74. The glass substrates 24 stored in the substrate storage frame 71 are attracted one by one by a suction pad 79 on a hand 75a of a robot 75, taken out from the substrate storage frame 71, and inserted into the substrate heating units 74.

Downstream of the substrate heating units 74, there are disposed a stopper 77 for abutting against the leading end of a glass substrate 24 and holding the glass substrate 24, and a position sensor 78 for detecting the position of the leading end of the glass substrate 24. The position sensor 78 detects the position of the leading end of the glass substrate 24 on its way toward the attachment position. After the position sensor 78 has detected the position of the leading end of the glass substrate 24, the glass substrate 24 is fed a predetermined distance and is positioned between rubber rollers 80a, 80b of the attachment mechanism 46. Preferably, a plurality of position sensors 78 are disposed at predetermined intervals along the feed path for monitoring the times at which a glass substrate 24 reaches the respective positions of the position sensors 78, thereby to check a delay due to a slippage or the like of the glass substrate 24 when the glass substrate 24 starts to be fed. In FIG. 1, glass substrates 24 are heated by the substrate heating units while the glass substrates 24 are being fed. However, glass substrates 24 may be heated in a batch-heating oven and fed by a robot.

The attachment mechanism 46 has a pair of vertically spaced laminating rubber rollers 80a, 80b that can be heated to a predetermined temperature. The attachment mechanism 46 also has a pair of backup rollers 82a, 82b held in rolling contact with the rubber rollers 80a, 80b, respectively. The backup roller 82b is pressed against the rubber roller 80b by a roller clamp unit 83.

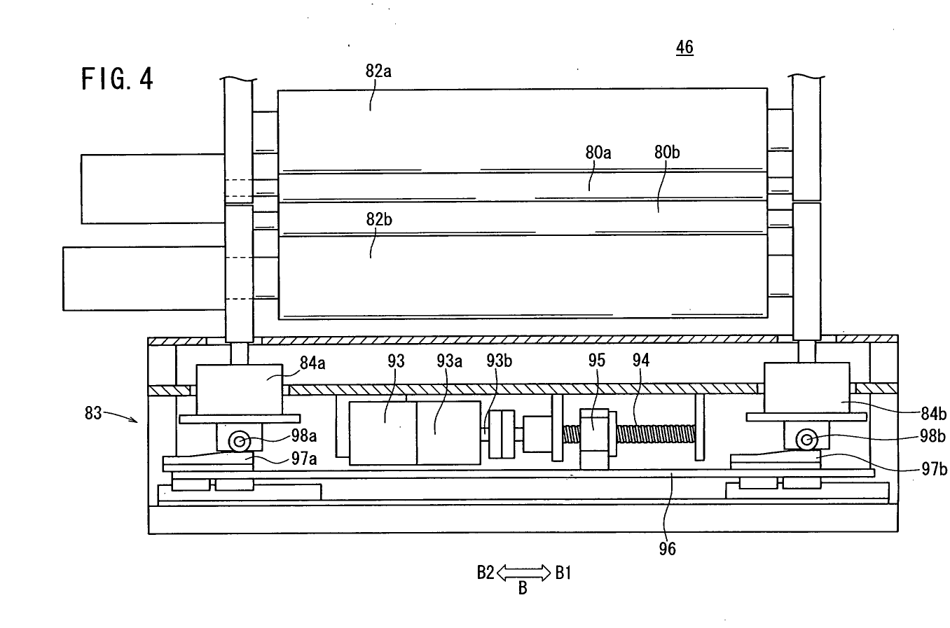

As shown in FIG. 4, the roller clamp unit 83 has a drive motor (actuator) 93 having a drive shaft coupled to a speed reducer 93a which has a drive shaft 93b coaxially connected to a ball screw 94. A nut 95 is threaded over the ball screw 94 and fixed to a slide base 96. Tapered cams 97a, 97b (cam section) are fixedly mounted on respective opposite ends of the slide base 96 in the transverse direction of the photosensitive web 22, which is indicated by the arrow B. The tapered cams 97a, 97b are progressively higher in the direction indicated by the arrow B1. Rollers 98a, 98b are placed on the respective tapered cams 97a, 97b and held on the respective lower ends of pressing cylinders 84a, 84b.

As shown in FIG. 1, a contact prevention roller 86 is movably disposed near the rubber roller 80a for preventing the photosensitive web 22 from contacting the rubber roller 80a. A preheating unit 87 for preheating the photosensitive web 22 to a predetermined temperature is disposed upstream of and closely to the attachment mechanism 46. The preheating unit 87 comprises an infrared bar heater or a heat applying means.

Glass substrates 24 are fed from the attachment mechanism 46 through the inter-substrate web cutting mechanism 48 along a feed path 88 which extends in the direction indicated by the arrow C. The feed path 88 comprises an array of rollers including film feed rollers 90 and substrate feed rollers 92 with the web cutting mechanism 48a interposed therebetween. The distance between the rubber rollers 80a, 80b and the substrate feed rollers 92 is equal to or less than the length of one glass substrate 24.

In the manufacturing apparatus 20, the reel-out mechanism 32, the processing mechanism 36, the label bonding mechanism 40, the reservoir mechanism 42, the peeling mechanism 44, the tension control mechanism 66, and the detecting mechanism 47 are disposed above the attachment mechanism 46. Conversely, the reel-out mechanism 32, the processing mechanism 36, the label bonding mechanism 40, the reservoir mechanism 42, the peeling mechanism 44, the tension control mechanism 66, and the detecting mechanism 47 may be disposed below the attachment mechanism 46, so that the photosensitive web 22 may be rendered upside down such that the photosensitive resin layer 28 is attached to the lower surfaces of glass substrates 24. Alternatively, all the mechanisms of the manufacturing apparatus 20 may be linearly arrayed.

As shown in FIG. 1, the manufacturing apparatus 20 is controlled in its entirety by a lamination process controller 100. The manufacturing apparatus 20 also has a lamination controller 102, a substrate heating controller 104, etc. for controlling the different functional components of the manufacturing apparatus 20. These controllers are interconnected by an in-process network. The lamination process controller 100 is connected to the network of a factory which incorporates the manufacturing apparatus 20, and performs information processing for production, e.g., production management and mechanism operation management, based on instruction information (condition settings and production information) from a factory CPU (not shown).

The substrate heating controller 104 controls the substrate heating units 74 to receive glass substrates 24 from an upstream process and heat the received glass substrates 24 to a desired temperature, controls the feeder 76 to feed the heated glass substrates 24 to the attachment mechanism 46, and also controls the handling of information about the glass substrates 24.

The lamination controller 102 serves as process master for controlling the functional components of the manufacturing apparatus 20. The lamination controller 102 operates as a control mechanism for controlling, for example, the substrate feed mechanism 45 based on the positional information, detected by the detecting mechanism 47, of the partly cut regions 34 of the photosensitive web 22.

The installation space of the manufacturing apparatus 20 is divided into a first clean room 112a and a second clean room 112b by a partition wall 110. The first clean room 112a houses therein the reel-out mechanism 32, the processing mechanism 36, the label bonding mechanism 40, the reservoir mechanism 42, the peeling mechanism 44, and the tension control mechanism 66. The second clean room 112b houses therein the detecting mechanism 47 and the other components following the detecting mechanism 47. The first clean room 112a and the second clean room 112b are connected to each other by a through region 114.

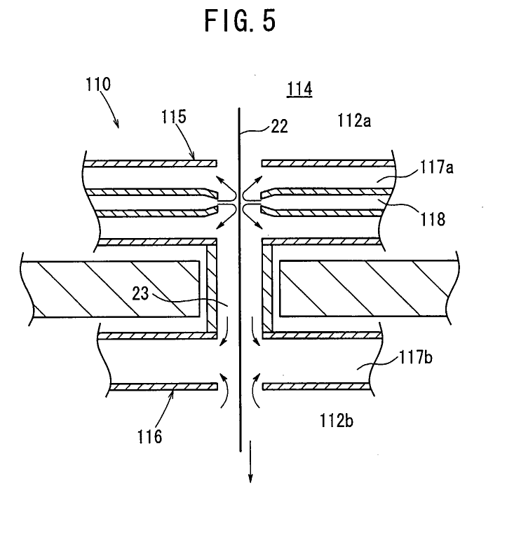

As shown in FIG. 5, the through region 114 has a deduster 115 disposed in the first clean room 112a and an air sealer 116 disposed in the second clean room 112b.

The deduster 115 has a pair of suction nozzles 117a disposed in confronting relation to opposite surfaces of the photosensitive web 22, and a pair of ejection nozzles 118 disposed respectively in the suction nozzles 117a. The ejection nozzles 118 eject air to the photosensitive web 22 to remove dust particles from the photosensitive web 22, and the suction nozzles 117a draw the ejected air and the removed dust particles. Alternatively, only the suction nozzle 117a, but not the ejection nozzle 118, may be disposed.

The air sealer 116 has a pair of suction nozzles 117b disposed in confronting relation to opposite surfaces of the photosensitive web 22. The suction nozzles 117b draw air to seal the through region 114. The deduster 115 and the air sealer 116 may be switched around in position, or a plurality of dedusters 115 and a plurality of air sealers 116 may be combined with each other. Only the suction nozzle 117a, but not the ejection nozzle 118, may be disposed in confronting relation to the side of the photosensitive web 22 where the photosensitive resin layer 28 is exposed.

In the manufacturing apparatus 20, the partition wall 110 prevents heated air from the attachment mechanism 46 from thermally affecting the photosensitive web 22, i.e., from wrinkling, deforming, thermally shrinking, or stretching the photosensitive web 22. The partition wall 110 separates an upper area of the manufacturing apparatus 20, i.e., the first clean room 112a, where dust particles are liable to occur and fall, from a lower area of the manufacturing apparatus 20, i.e., the second clean room 112b, thereby keeping the attachment mechanism 46 in particular clean. It is desirable to keep the pressure in the second clean room 112b higher than the pressure in the first clean room 112a, thereby preventing dust particles from flowing from the first clean room 112a into the second clean room 112b.

An air supply (not shown) for supplying a downward flow of clean air is disposed in an upper portion of the second clean room 112b.

Operation of the manufacturing apparatus 20 for carrying out a manufacturing method according to the present invention will be described below.

Initially for positioning the leading end of the photosensitive web 22 in place, the photosensitive web 22 is unreeled from the photosensitive web roll 22a accommodated in the reel-out mechanism 32. The photosensitive web 22 is delivered through the processing mechanism 36, the label bonding mechanism 40, the reservoir mechanism 42, the peeling mechanism 44, and the attachment mechanism 46 to the film feed rollers 90. The leading end of the photosensitive web 22 is pinched by the film feed rollers 90.

When a partly cut region 34 is detected by the photoelectric sensor 72, the film feed roller 90 is rotated based on a detected signal from the photoelectric sensor 72. The photosensitive web 22 is now fed a predetermined distance to the attachment position by the film feed roller 90. The partly cut region 34 is positioned correspondingly to the attachment position. Alternatively, the partly cut region 34 may be detected at a downstream position of the attachment position, and the photosensitive web 22 may be stopped at a predetermined position.

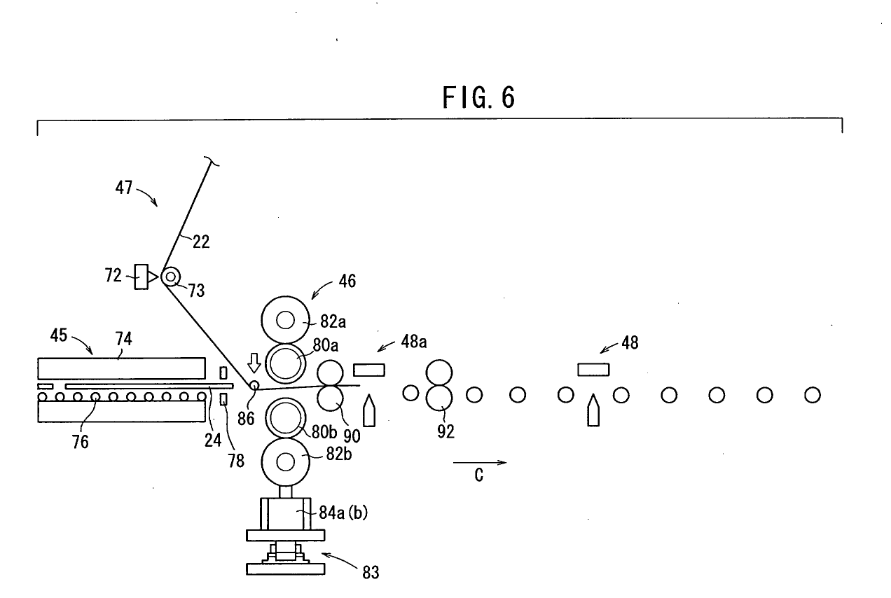

As shown in FIG. 6, the contact prevention roller 86 is lowered to prevent the photosensitive web 22 from contacting the rubber roller 80a. A glass substrate 24 is waiting immediately prior to the attachment position. The photosensitive web 22 is now in an initial state of the manufacturing apparatus 20.

Operation of the functional components of the manufacturing apparatus 20 in a lamination mode will be described below.

As shown in FIG. 1, in the processing mechanism 36, the circular blade 52 moves transversely across the photosensitive web 22 to cut into the protective film 30, the photosensitive resin layer 28, and the base film 26, thereby forming a partly cut region 34 (see FIG. 2). Then, the photosensitive web 22 is fed again a distance corresponding to the dimension of the residual section 30b of the protective film 30 in the direction indicated by the arrow A (see FIG. 1), and then stopped, whereupon another partly cut region 34 is formed therein by the circular blade 52. As shown in FIG. 2, a front peel-off section 30aa and a rear peel-off section 30ab are now provided in the photosensitive web 22, with the residual section 30b interposed therebetween.

Then, the photosensitive web 22 is fed to the label bonding mechanism 40 to place a predetermined bonding area of the protective film 30 on the support base 56. In the label bonding mechanism 40, a predetermined number of adhesive labels 38 are attracted under suction and held by the suction pads 54b through 54e and are securely bonded to the front peel-off section 30aa and the rear peel-off section 30ab of the protective film 30 across the residual section 30b thereof (see FIG. 3).

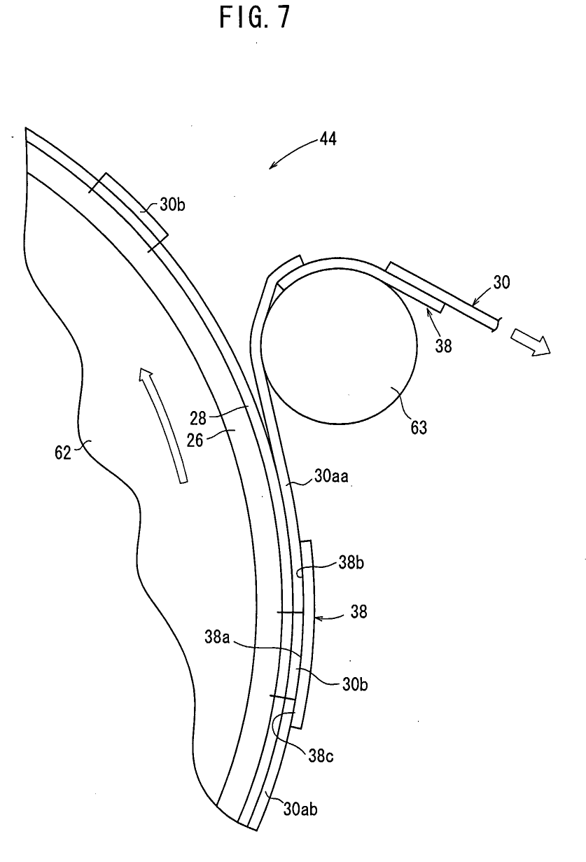

The photosensitive web 22 with the five adhesive labels 38 bonded thereto, for example, is isolated by the reservoir mechanism 42 from variations of the tension to which the supplied photosensitive web 22 are subjected, and then continuously fed to the peeling mechanism 44. In the peeling mechanism 44, as shown in FIG. 7, the base film 26 of the photosensitive web 22 is attracted to the suction drum 62, and the protective film 30 is peeled off from the photosensitive web 22, leaving the residual sections 30b. The protective film 30 is peeled off at a sharp peel-off angle and wound by the protective film takeup unit 64 (see FIG. 1). Preferably, electric neutralizing air may be blown on the peeled portions.

At this time, inasmuch as the photosensitive web 22 is firmly held by the suction drum 62, shocks produced when the protective film 30 is peeled off from the photosensitive web 22 are not transferred to the photosensitive web 22 downstream of the suction drum 62. Consequently, such shocks are not transferred to the attachment mechanism 46, and hence laminated sections of glass substrates 24 are effectively prevented from developing a striped defective region.

After the protective film 30 has been peeled off from the base film 26, leaving the residual sections 30b, by the peeling mechanism 44, the photosensitive web 22 is adjusted in tension by the tension control mechanism 66, and then the partly cut region 34 of the photosensitive web 22 is detected by the photoelectric sensor 72 of the detecting mechanism 47.

Based on detected information of the partly cut region 34, the film feed rollers 90 are rotated to feed the photosensitive web 22 a predetermined length to the attachment mechanism 46. At this time, the contact prevention roller 86 is waiting above the photosensitive web 22 and the rubber roller 80b is disposed below the photosensitive web 22.

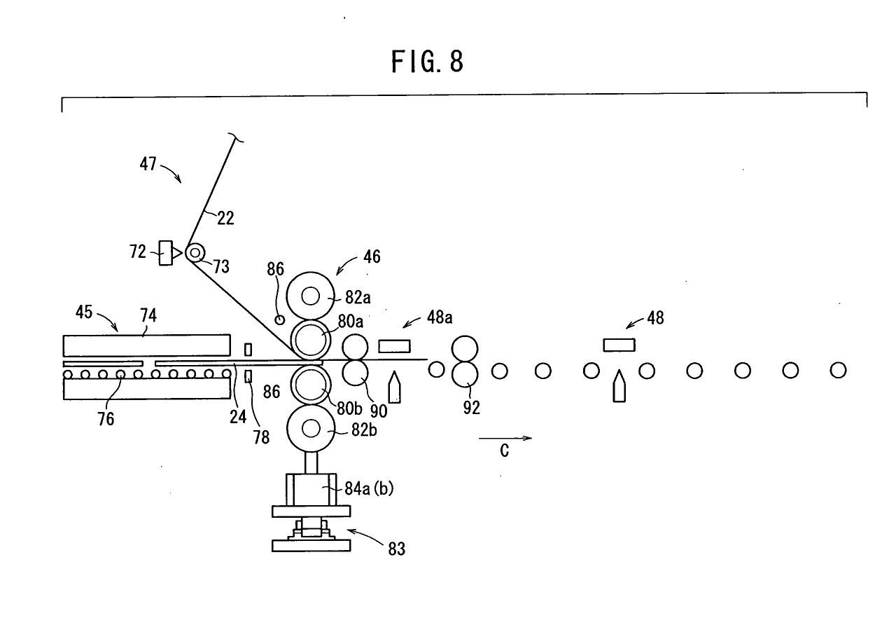

As shown in FIG. 8, the first glass substrate 24 which is preheated is fed to the attachment position by the substrate feed mechanism 45. The glass substrate 24 is tentatively positioned between the rubber rollers 80a, 80b in alignment with the attached photosensitive resin layer 28 of the photosensitive web 22.

Then, as shown in FIG. 4, the ball screw 94 is rotated in a certain direction by the speed reducer 93a coupled to the drive motor 93, moving the slide base 96 in the direction indicated by the arrow B2 in unison with the nut 95 threaded over the ball screw 94. Therefore, the tapered cams 97a, 97b have their cam surfaces in contact with the rollers 98a, 98b raised, displacing the rollers 98a, 98b upwardly. The pressing cylinders 84a, 84b are elevated, lifting the backup roller 82b and the rubber roller 80b to sandwich the glass substrate 24 under a predetermined pressing pressure between the rubber rollers 80a, 80b. At this time, the pressing pressure is adjusted by the pressure of air supplied to the pressing cylinders 84a, 84b. The rubber roller 80a is rotated to transfer, i.e., laminate, the photosensitive resin layer 28, which is melted with heat, to the glass substrate 24.

The photosensitive resin layer 28 is laminated onto the glass substrate 24 under such conditions that the photosensitive resin layer 28 is fed at a speed in the range from 1.0 m/min. to 10.0 m/min., the rubber rollers 80a, 80b have a temperature ranging from 100° C. to 150° C., and a hardness ranging from 40 to 90, and apply a pressure (linear pressure) ranging from 50 N/cm to 400 N/cm.

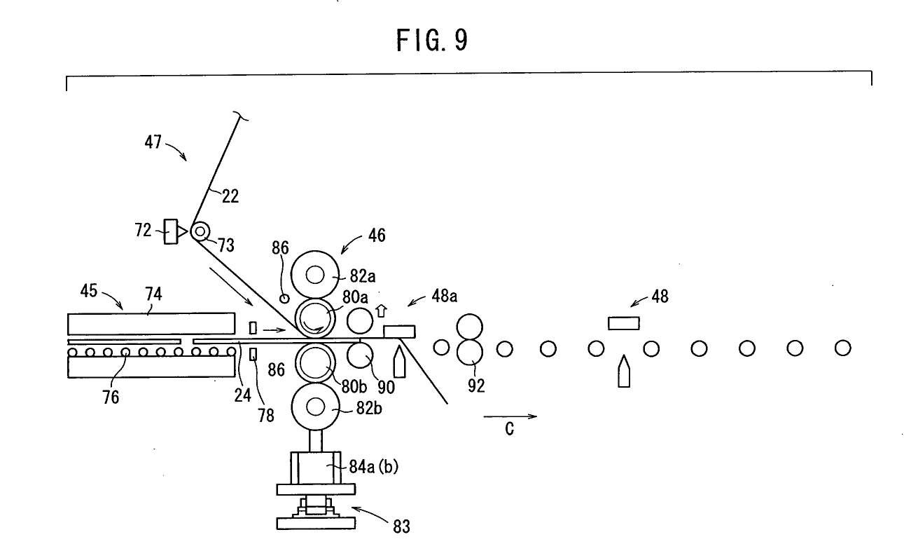

As shown in FIG. 9, when the leading end of the glass substrate 24 reaches a position near the film feed rollers 90, the film feed rollers 90 are moved away from the glass substrate 24. When the leading end of the photosensitive web 22 which projects forwardly of the glass substrate 24 in the direction indicated by the arrow C reaches a predetermined position with respect to the web cutting mechanism 48a, the web cutting mechanism 48a is actuated to cut off the leading end of the photosensitive web 22. The web cutting mechanism 48a returns to its standby position except for the time of cutting off the leading end of the photosensitive web 22, the time of operation termination, and the time of cutting off the photosensitive web 22 in case of trouble. The web cutting mechanism 48a will not be used while the manufacturing apparatus 20 is in normal operation.

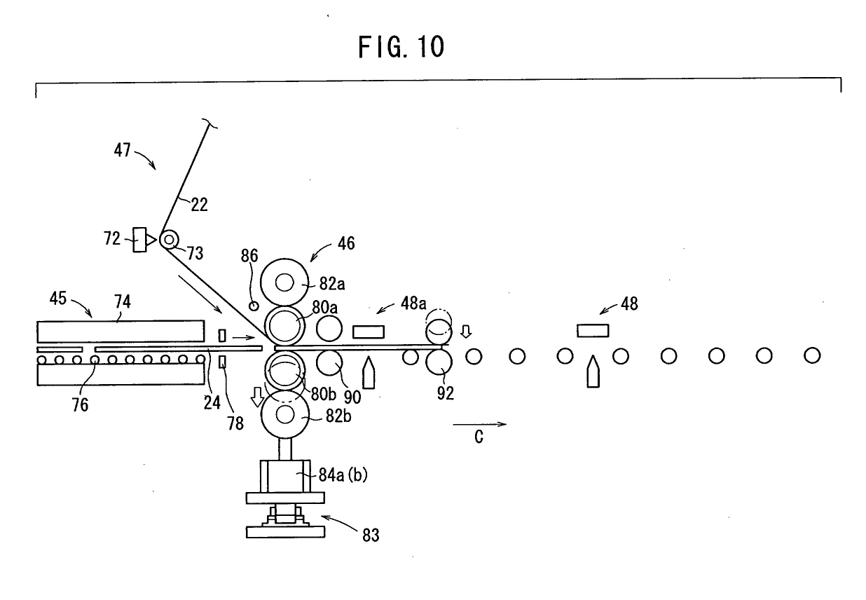

As shown in FIG. 10, when the photosensitive web 22 has been laminated onto the glass substrate 24 up to its trailing end by the rubber rollers 80a, 80b, the rubber roller 80a is stopped against rotation, and the glass substrate 24 with the laminated photosensitive web 22 (also referred to as “attached substrate 24a”) is clamped by the substrate feed rollers 92.

The rubber roller 80b is retracted away from the rubber roller 80a, unclamping the attached substrate 24a. Specifically, as shown in FIG. 4, the speed reducer 93a coupled to the drive motor 93 is reversed, causing the ball screw 94 and the nut 95 to move the slide base 96 in the direction indicated by the arrow B1. Therefore, the tapered cams 97a, 97b have their cam surfaces in contact with the rollers 98a, 98b lowered, displacing the pressing cylinders 84a, 84b downwardly. The backup roller 82b and the rubber roller 80b are lowered, unclamping the attached substrate 24a.

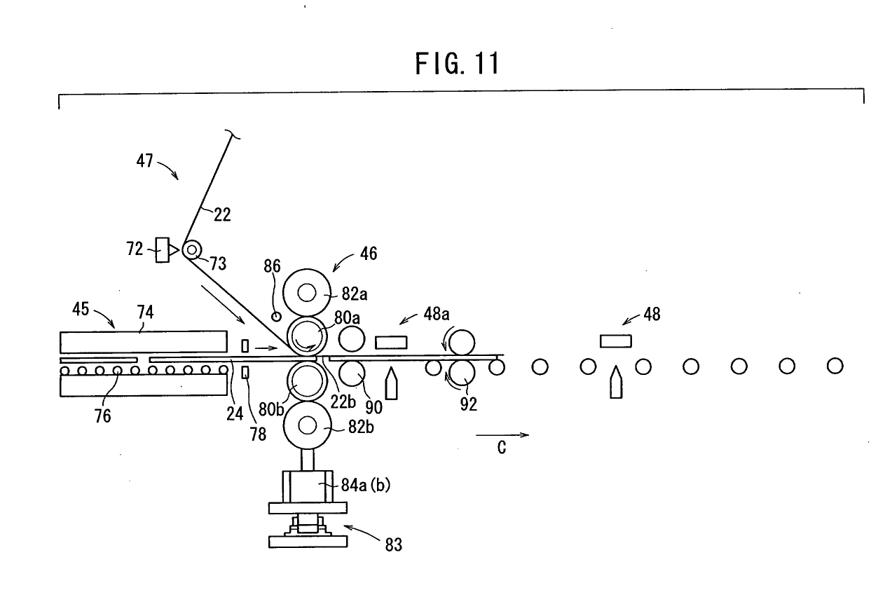

The substrate feed rollers 92 then start rotating to feed the attached substrate 24a a predetermined distance in the direction indicated by the arrow C. The position 22b of the photosensitive web 22 which is to be brought between two adjacent glass substrates 24 is now displaced to a position beneath the rubber roller 80a. A next glass substrate 24 is fed toward the attachment position by the substrate feed mechanism 45. When the leading end of the next glass substrate 24 is positioned between the rubber rollers 80a, 80b, the rubber roller 80b is lifted, clamping the next glass substrate 24 and the photosensitive web 22 between the rubber rollers 80a, 80b. At the same time, the substrate feed rollers 92 clamp the attached substrate 24a. The rubber rollers 80a, 80b and the substrate feed roller 92 are rotated to start laminating the photosensitive web 22 onto the glass substrate 24 and feed a attached substrate 24a in the direction indicated by the arrow C (see FIG. 11).

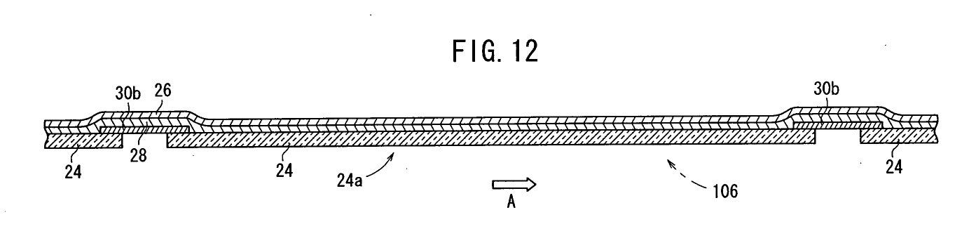

At this time, as shown in FIG. 12, the attached substrate 24a has opposite ends covered with respective residual sections 30b.

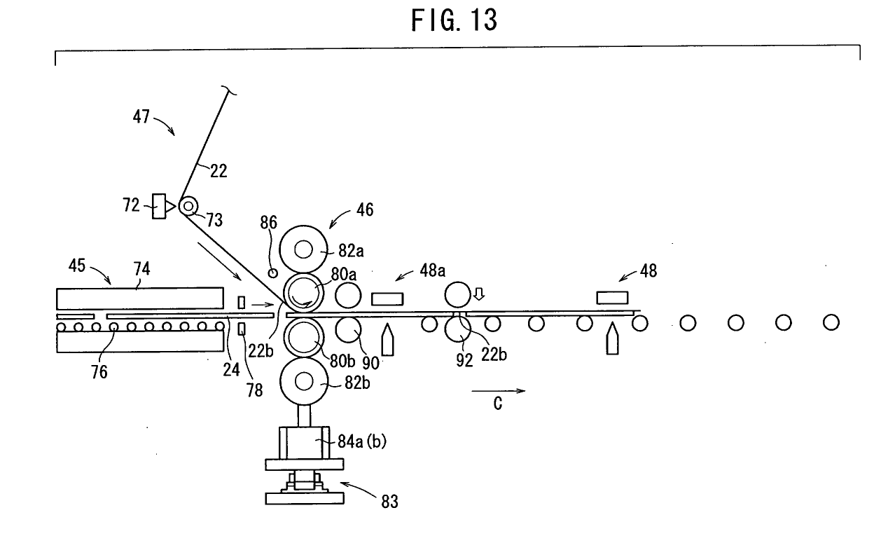

As shown in FIG. 13, when the trailing end of the first attached substrate 24a reaches the substrate feed rollers 92, the upper one of the substrate feed rollers 92 is lifted to unclamp the first attached substrate 24a, and the lower one of the substrate feed rollers 92 and the other rollers of the feed path 88 are continuously rotated to feed the attached substrate 24a. When the trailing end of the next, i.e., second, attached substrate 24a reaches a position near the rubber rollers 80a, 80b, the rubber rollers 80a, 80b and the substrate feed rollers 92 are stopped against rotation. The upper one of the substrate feed rollers 92 is lowered to clamp the second attached substrate 24a, and the rubber roller 80b is lowered to unclamp the second attached substrate 24a. Then, the substrate feed rollers 92 are rotated to feed the second attached substrate 24a. The position 22b of the photosensitive web 22 which is to be brought between two adjacent glass substrates 24 is now displaced to the position beneath the rubber roller 80a, and the photosensitive webs 22 are repeatedly laminated onto third and the following glass substrates 24.

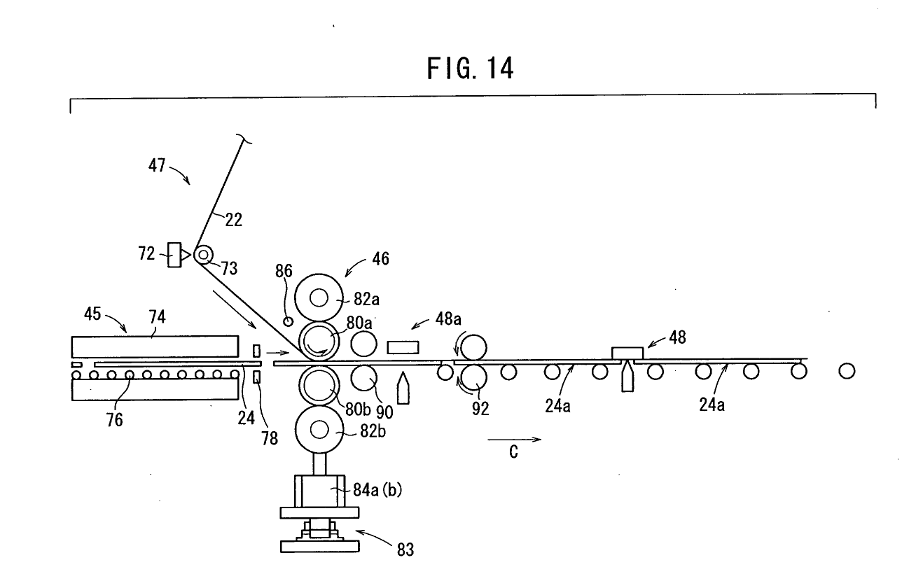

As shown in FIG. 14, when the position between two adjacent attached substrates 24a reaches a position corresponding to the inter-substrate web cutting mechanism 48, the inter-substrate web cutting mechanism 48 severs the photosensitive web 22 between the attached substrates 24a while moving in the direction indicated by the arrow C at the same speed as the attached substrates 24a. Thereafter, the inter-substrate web cutting mechanism 48 returns to a standby position, and the base films 26 and the residual sections 30b are peeled off from the leading attached substrate 24a, thereby manufacturing a photosensitive laminated body 106.

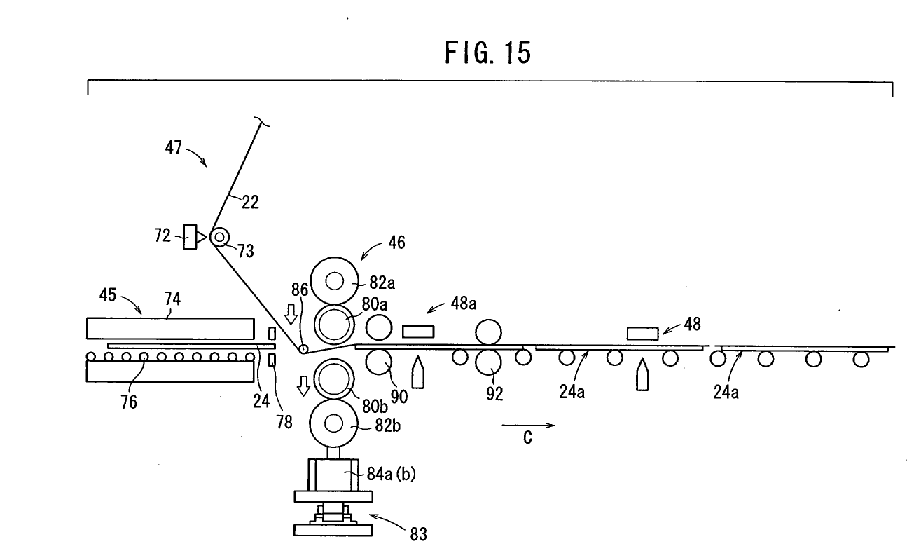

When the laminating process is temporarily stopped, as shown in FIG. 15, the film feed rollers 90 and the rubber roller 80b are brought into unclamping positions, and the contact prevention roller 86 is lowered to prevent the photosensitive web 22 from contacting the rubber roller 80a.

When the manufacturing apparatus 20 is to be shut off, the substrate feed rollers 92 are rotated to feed the attached substrate 24a in the direction indicated by the arrow C, and the film feed rollers 90 clamp the photosensitive web 22. While the film feed rollers 90 in rotation are clamping the photosensitive web 22, the web cutting mechanism 48a travels transversely across the photosensitive web 22, cutting off the photosensitive web 22.

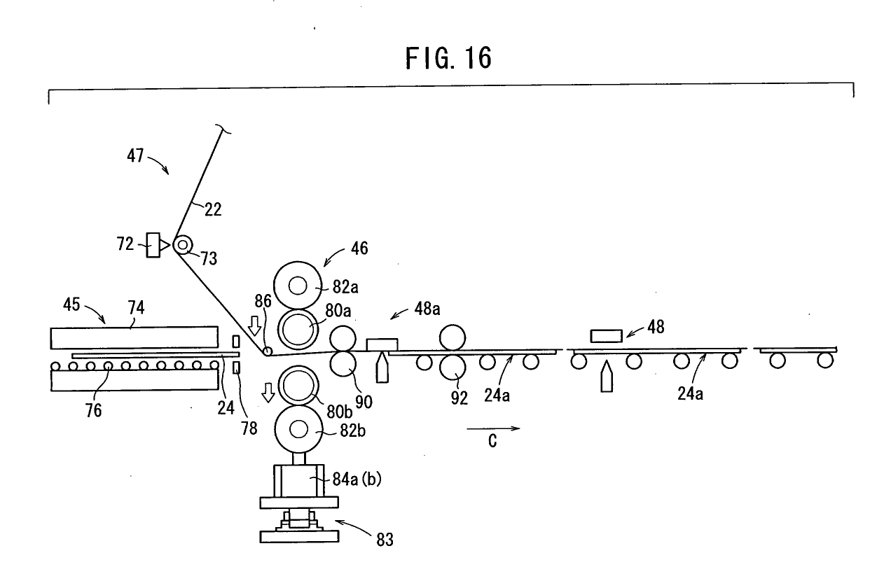

Consequently, as shown in FIG. 16, the photosensitive web 22 passes between the rubber rollers 80a, 80b and is sandwiched by the film feed rollers 90, and is supported away from the rubber roller 80a by the contact prevention roller 86 which is lowered. The web cutting mechanism 48a has been placed in its standby position.

When the inter-substrate web cutting mechanism 48 and the web cutting mechanism 48a cut off the photosensitive web 22, they move in synchronism with the photosensitive web 22 in the direction indicated by the arrow C. However, the inter-substrate web cutting mechanism 48 and the web cutting mechanism 48a may move only transversely across the photosensitive web 22 to cut off the photosensitive web 22. The photosensitive web 22 may be cut off by a Thompson blade while the web is held at rest, or may be cut off by a rotary blade while the web is in motion.

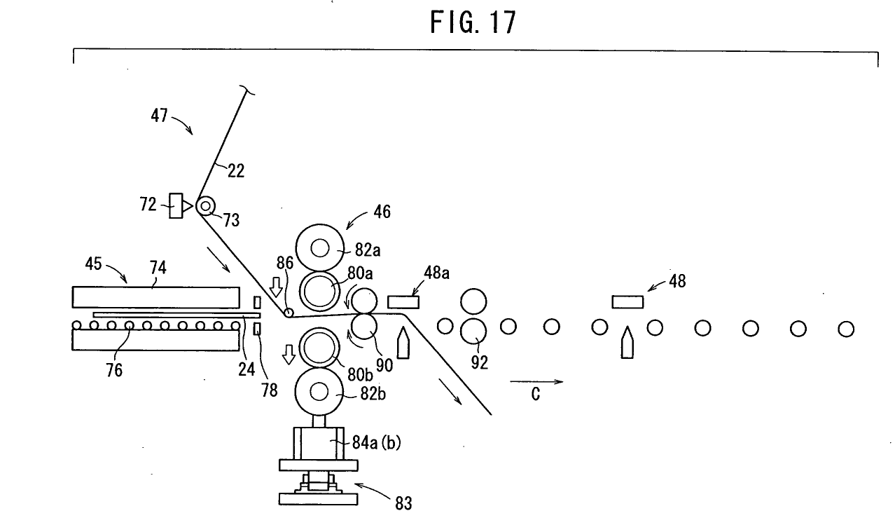

When the manufacturing apparatus 20 operates in its initial state, as shown in FIG. 17, the contact prevention roller 86 is disposed in the lower position and the rubber roller 80b is spaced away from the rubber roller 80a. Then, the film feed roller 90 is rotated to discharge the photosensitive web 22 into a web disposal container (not shown). At this time, the photosensitive web 22 is severed into a certain length by the web cutting mechanism 48a.

When the detecting mechanism 47 detects the partly cut region 34 of the photosensitive web 22, the photosensitive web 22 is fed a predetermined length from the detected position. Specifically, when the contact prevention roller 86 is elevated, the photosensitive web 22 is fed until the partly cut region 34 reaches a position where the photosensitive web 22 is to be laminated by the rubber rollers 80a, 80b. The leading end of the photosensitive web 22 is now positioned in place.

In the first embodiment, the partly cut region 34 of the photosensitive web 22 is directly detected by the detecting mechanism 47 upwardly of and closely to the attachment mechanism 46. The distance from the detecting mechanism 47 to the position where the partly cut region 34 is stopped by the rubber rollers 80a, 80b needs to be smaller than the shortest length of the photosensitive web 22 to be laminated. This is because the information of the detected partly cut region 34 is used for a next laminating process through feedback.

The detecting mechanism 47 performs two measuring processes as described below. According to the first measuring process, the rubber rollers 80a, 80b clamp the glass substrate 24, and the number of pulses generated by an encoder combined with a drive motor (not shown) for rotating the rubber rollers 80a, 80b, as representing the distance by which the glass substrate 24 is fed from the start of rotation of the rubber rollers 80a, 80b, is compared with the preset numbers of pulses generated when the partly cut region 34 is to be detected by the detecting mechanism 47, thereby measuring displacements of the partly cut region 34. If the partly cut region 34 of the photosensitive web 22 is detected before the preset number of pulses is reached, then the partly cut region 34 is judged as being displaced forwardly of a predetermined position on the glass substrate 24 by a distance indicated by the difference between the numbers of pulses. Conversely, if the partly cut region 34 of the photosensitive web 22 is detected after the preset number of pulses is reached, then the partly cut region 34 is judged as being displaced rearwardly of a predetermined position on the glass substrate 24.

According to the second measuring process, the number of pulses generated by an encoder combined with a drive motor (not shown) for rotating the rubber rollers 80a, 80b is measured from the detection of a partly cut region 34 to the detection of a next partly cut region 34, thereby measuring the laminated length H of the photosensitive web 22. The preset number of pulses corresponding to the laminated length H under normal conditions of each of the photosensitive web 22 is compared with the actually measured number of pulses. If the actually measured number of pulses is greater than the preset number of pulses, then the photosensitive web 22 is judged as being stretched due to heat or the like by a distance indicated by the difference between the numbers of pulses. If the actually measured number of pulses is smaller than the preset number of pulses, then the photosensitive web 22 is judged as being short.

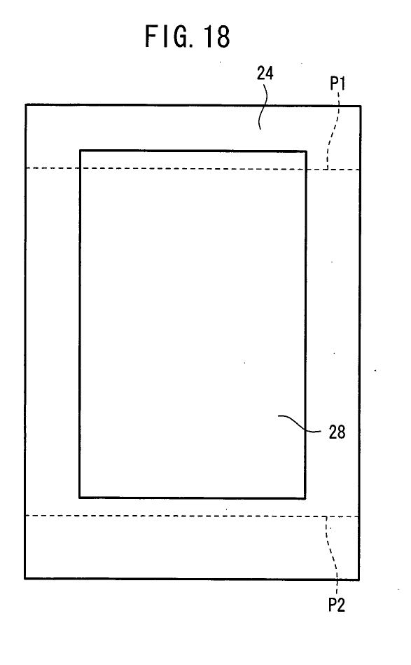

If the leading end of the photosensitive resin layer 28 is detected as being displaced (advanced) equal distances or substantially equal distances with respect to an attached range P1-P2 of the glass substrate 24 according to the first measuring process, as shown in FIG. 18, then the relative position of the glass substrate 24 and the partly cut regions 34 of the photosensitive web 22 is adjusted.

Specifically, if the partly cut region 34 detected by the photoelectric sensor 72 is detected as being advanced from a predetermined position, then as shown in FIG. 10, the substrate feed rollers 92 feed unattached portions of the photosensitive web 22 after being laminated by a distance represented by the difference between the preset distance and the advanced distance. As a result, the partly cut region 34 is positionally adjusted and placed in a predetermined position between the rubber rollers 80a, 80b. Thereafter, the glass substrate 24 is delivered under normal delivery control between the rubber rollers 80a, 80b, and the photosensitive resin layer 28 is attached at a normal position to the glass substrate 24, i.e., in the attached range P1-P2 of the glass substrate 24.

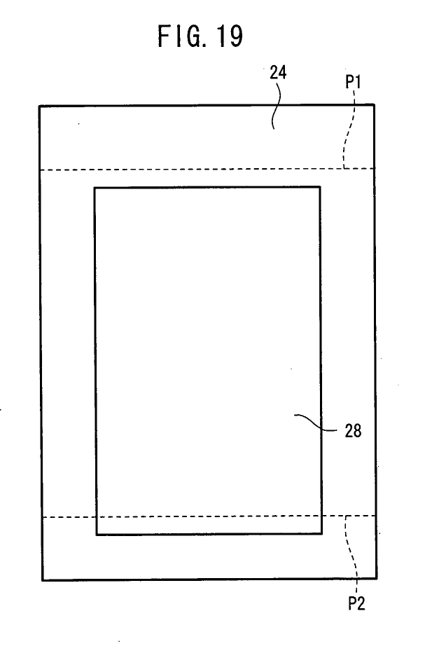

As shown in FIG. 19, if the partly cut region 34 detected by the photoelectric sensor 72 is detected as being delayed from the attached range P1-P2 of the glass substrate 24, then the substrate feed rollers 92 feed unattached portions of the photosensitive web 22 after being laminated by a distance represented by the sum of the preset distance and the delayed distance.

Rather than adjusting the distance that the attached substrate 24a is fed by the substrate feed rollers 92, the substrate feed mechanism 45 may be controlled to adjust the position at which the glass substrate 24 is to be stopped, by the advanced or delayed distance.

The distance between the partly cut regions 34 detected by the photoelectric sensor 72, i.e., the length H of the photosensitive resin layer 28 to be attached to the glass substrate 24, is measured according to the second measuring process. If the length H is greater than the attached range, then the positions of the partly cut regions 34 are changed by the processing mechanism 36 so that the distance between the partly cut regions 34, i.e., the length H, is reduced by the difference. If the length H is smaller than the attached range, then the positions of the partly cut regions 34 are changed by the processing mechanism 36 so that the distance between the partly cut regions 34, i.e., the length H, is increased by the difference. In this manner, the attached length of the photosensitive resin layer 28 is adjusted to a predetermined length.

It is also possible to change the amount of stretch of the photosensitive web 22 by adjusting the tension of the photosensitive web 22 with the tension dancer 70 of the tension control mechanism 66.

Consequently, the partly cut regions 34 of the photosensitive web 22 can be positioned highly accurately with respect to the attachment position, allowing the photosensitive resin layer 28 of the photosensitive web 22 to be attached accurately in a desired area of the glass substrate 24. It is thus possible to efficiently manufacture a high-quality photosensitive laminated body 106 through a simple process and arrangement.

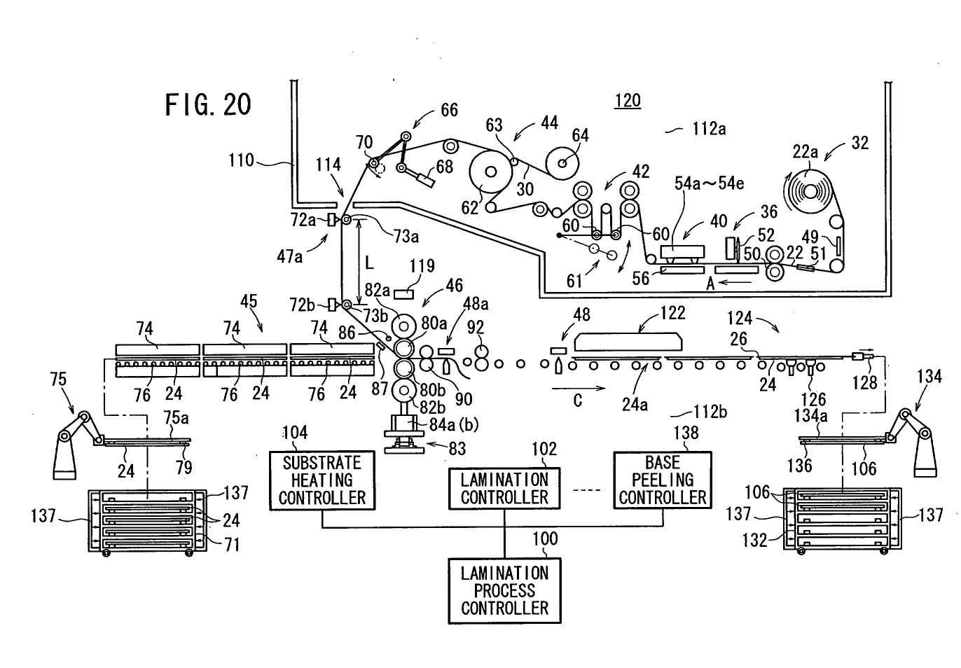

FIG. 20 schematically shows in side elevation a manufacturing apparatus 120 according to a second embodiment of the present invention. Those parts of the manufacturing apparatus 120 according to the second embodiment which are identical to those of the manufacturing apparatus 20 according to the first embodiment are denoted by identical reference characters, and will not be described in detail below.

As shown in FIG. 20, the manufacturing apparatus 120 has a detecting mechanism 47a, a cooling mechanism 122 disposed downstream of the inter-substrate web cutting mechanism 48, and a base peeling mechanism 124 disposed downstream of the cooling mechanism 122. The detecting mechanism 47a has photoelectric sensors 72a, 72b, which are spaced from each other by a predetermined distance L and disposed in confronting relation to backup rollers 73a, 73b, respectively.

The cooling mechanism 122 supplies cold air to an attached substrate 24a to cool the attached substrate 24a after the photosensitive web 22 is cut off between the attached substrate 24a and a following attached substrate 24a by the inter-substrate web cutting mechanism 48. Specifically, the cooling mechanism 122 supplies cold air having a temperature of 10° C. at a rate ranging from 1.0 to 2.0 m/min. Alternatively, the cooling mechanism 122 may be dispensed with, and the attached substrate 24a may be cooled in a photosensitive laminated body storage frame 132 (described later) without using any dedicated equipment for cooling.

The base peeling mechanism 124 disposed downstream of the cooling mechanism 122 has a plurality of suction pads 126 for attracting the lower surface of an attached substrate 24a. While the attached substrate 24a is being attracted under suction by the suction pads 126, the base films 26 and the residual sections 30b are peeled off from the attached substrate 24a by a robot hand 128. Electric neutralizing blowers (not shown) for ejecting ion air to four sides of the laminated area of the attached substrate 24a are disposed upstream, downstream, and laterally of the suction pads 126. The base films 26 and the residual sections 30b may be peeled off from the attached substrate 24a while a table for supporting the attached substrate 24a thereon is being oriented vertically, obliquely, or turned upside down for dust removal.

The base peeling mechanism 124 is followed downstream by the photosensitive laminated body storage frame 132 for storing a plurality of photosensitive laminated bodies 106. A photosensitive laminated body 106 that is produced when the base films 26 and the residual sections 30b are peeled off from the attached substrate 24a by the base peeling mechanism 124 is attracted by suction pads 136 on a hand 134a of a robot 134, taken out from the base peeling mechanism 124, and placed into the photosensitive laminated body storage frame 132.

Each of the substrate storage frame 71 and the photosensitive laminated body storage frame 132 has dedusting fan units (or duct units) 137 on three sides thereof except for a side from which the glass substrates 24 or the photosensitive laminated bodies 106 are placed into and taken out. The fan units 137 blow clean and electric neutralizing air into the substrate storage frame 71 and the photosensitive laminated body storage frame 132.

To the lamination process controller 100, there are connected the lamination controller 102, the substrate heating controller 104, and also a base peeling controller 138. The base peeling controller 138 controls the base peeling mechanism 124 to peel off the base film 26 from the attached substrate 24a that is supplied from the attachment mechanism 46, and also to discharge the photosensitive laminated body 106 to a downstream process. The base peeling controller 138 also handles information about the attached substrate 24a and the photosensitive laminated body 106.

In the detecting mechanism 47a according to the second embodiment, the photoelectric sensor 72a which is positioned upstream of the photoelectric sensor 72b first detects the partly cut region 34 of the photosensitive web 22. Thereafter, the downstream photoelectric sensor 72b detects the partly cut region 34 of the photosensitive web 22. The distance L between the backup rollers 73a, 73b corresponds to the length of the photosensitive resin layer 28 applied to the glass substrate 24.

The actual applied length of the photosensitive resin layer 28 can accurately be calculated from the difference between the time when the upstream photoelectric sensor 72a detects the partly cut regions 34 of the photosensitive web 22 and the time when the downstream photoelectric sensor 72b detects the same partly cut region 34 of the photosensitive web 22. Based on the calculated actual applied length of the photosensitive resin layer 28, the speed at which the photosensitive web 22 is fed is adjusted to apply the photosensitive resin layer 28 centrally to the glass substrate 24.

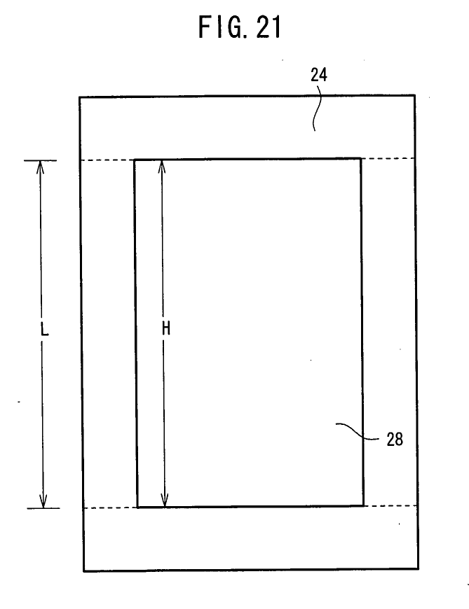

According to the second embodiment, therefore, the distance between the partly cut regions 34 of the photosensitive web 22, i.e., the length H of the photosensitive resin layer 28 applied to the glass substrate 24, is accurately detected to apply the photosensitive resin layer 28 centrally to the glass substrate 24 (see FIG. 21).

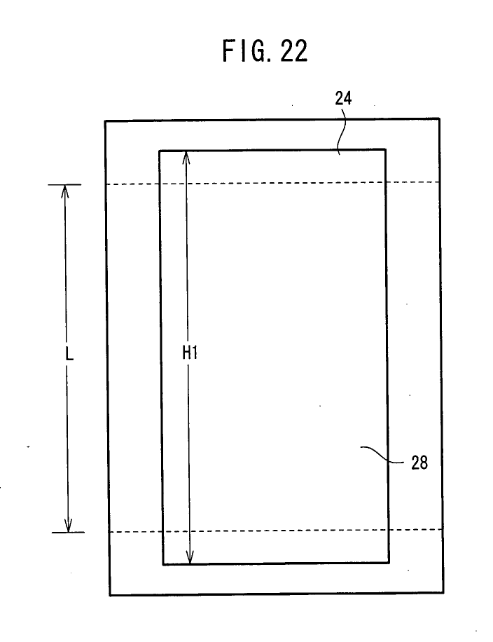

If the length H1 of the photosensitive resin layer 28 which is detected by the detecting mechanism 47a is larger than the normal length H, as shown in FIG. 22, then the photosensitive resin layer 28 is applied centrally to the glass substrate 24 such that the opposite ends of the photosensitive resin layer 28 are spaced equal distances outwardly from the ends of the applied length L.

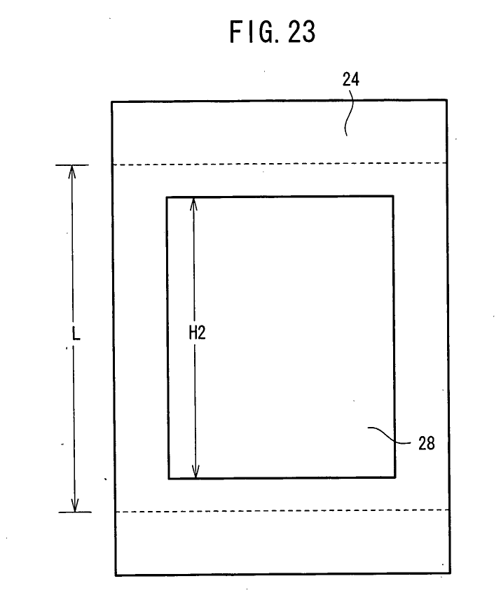

If the length H2 of the photosensitive resin layer 28 which is detected by the detecting mechanism 47a is smaller than the normal length H, as shown in FIG. 23, then the photosensitive resin layer 28 is applied centrally to the glass substrate 24 such that the opposite ends of the photosensitive resin layer 28 is spaced equal distances inwardly from the ends of the applied length L. In this case, a target displacement of the applied position of the photosensitive resin layer 28 is about one-half the displacement that occurs if the opposite ends of the photosensitive resin layer 28 is not spaced equal distances inwardly from the ends of the applied length L.

According to the second embodiment, furthermore, the partly cut regions 34 are formed in the photosensitive web 22 unreeled from the reel-out mechanism 32, and then the protective film 30 is peeled off, leaving the residual sections 30b, after which the photosensitive web 22 is laminated onto the glass substrate 24 to transfer the photosensitive resin layer 28, and then the base films 26 and the residual sections 30b are peeled off by the base peeling mechanism 124, thereby manufacturing the photosensitive laminated body 106. The photosensitive laminated body 106 can be manufactured easily automatically.

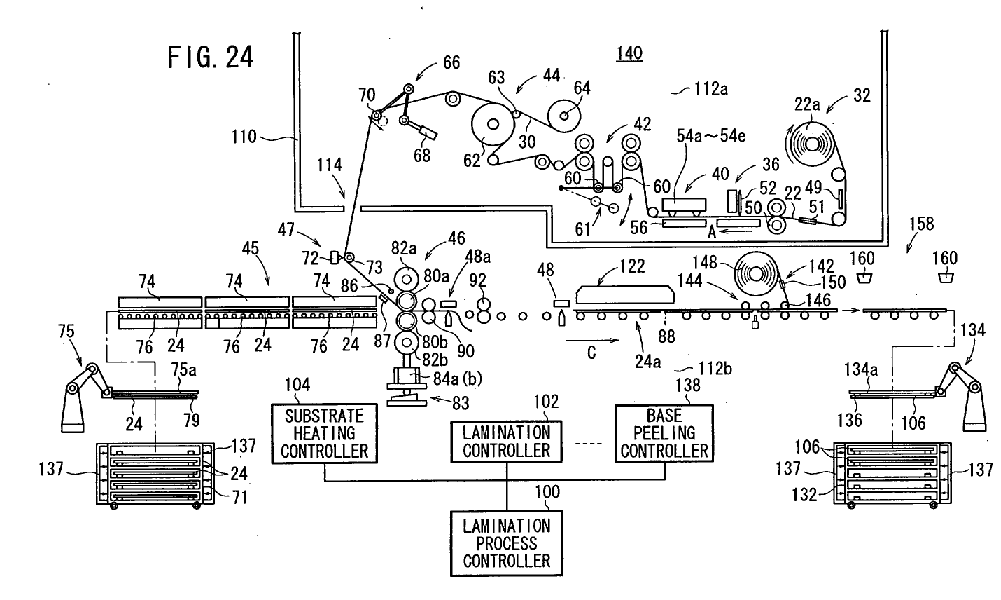

FIG. 24 schematically shows in side elevation a manufacturing apparatus 140 according to a third embodiment of the present invention. Those parts of the manufacturing apparatus 140 according to the third embodiment which are identical to those of the manufacturing apparatus 20 according to the first embodiment are denoted by identical reference characters, and will not be described in detail below.

The manufacturing apparatus 140 includes the inter-substrate web cutting mechanism 48 which is usually not used except for cutting off the photosensitive web 22 in case of trouble and separating the photosensitive web 22 to discharge defective sections. The manufacturing apparatus 140 has a cooling mechanism 122 and an automatic base peeling mechanism 142 which are disposed downstream of the web cutting mechanism 48a. The automatic base peeling mechanism 142 serves to continuously peel off elongate base films 26 by which glass substrates 24 spaced at given intervals are attached together. The automatic base peeling mechanism 142 has a prepeeler 144, a peeling roller 146 having a relatively small diameter, a takeup roll 148, and an automatic attaching unit 150. The takeup roll 148 performs torque control during operation thereof, for applying tension to the base film 26. For example, it is preferable that a tension feedback control be performed in accordance with a tension detecting device (not illustrated) which is disposed in the peeling roller 146.

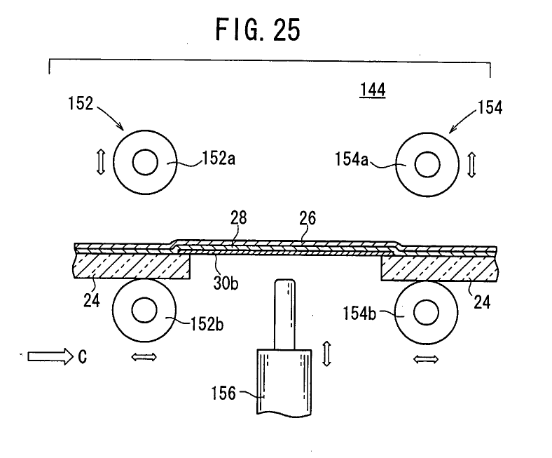

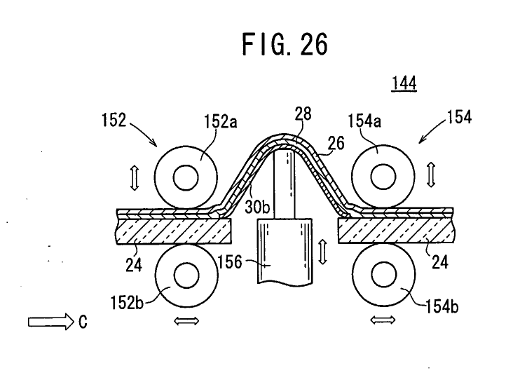

As shown in FIGS. 25 and 26, the prepeeler 144 has a pair of nip roller assemblies 152, 154 and a peeling bar 156. The nip roller assemblies 152, 154 are movable toward and away from each other in the direction in which glass substrates 24 are fed. The nip roller assemblies 152, 154 have vertically movable upper rollers 152a, 154a and lower rollers 152b, 154b. When the upper rollers 152a, 154a are lowered, the upper rollers 152a, 154a and the lower rollers 152b, 154b grip glass substrates 24 therebetween. The peeling bar 156 is vertically movable between adjacent glass substrates 24. The upper rollers 152a, 154a may be replaced with presser bars or presser pins.

The photosensitive web 22 is reheated to a temperature in the range from 30° C. to 120° C. by the peeling roller 146 or at a position immediately before the peeling roller 146. When the photosensitive web 22 is thus reheated, a color material layer 28 is prevented from being peeled off therefrom when the base film 26 is peeled off, so that a high-quality laminated surface can be produced on the glass substrates 24. The reheating may be performed by the peeling roller 146 that also functions as a heating roller such as a roller heated by hot water therein. Alternatively, the reheating may be performed by a separate bar heater or IR heater.

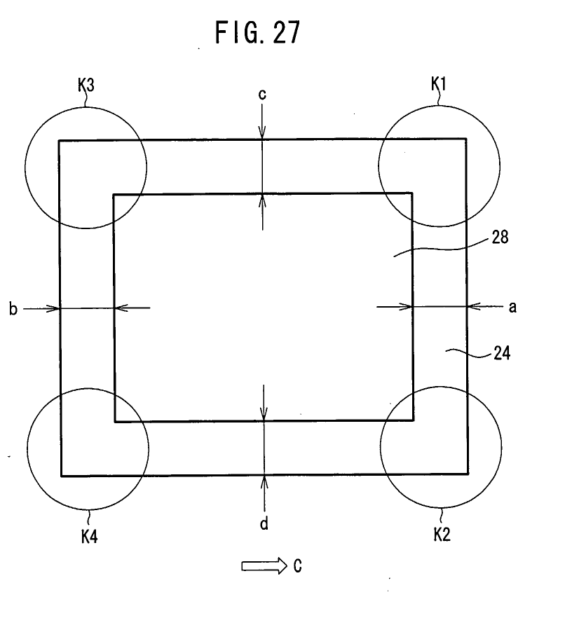

The automatic base peeling mechanism 142 is followed downstream by a measuring unit 158 for measuring the area of a photosensitive resin layer 28 that is actually attached to a glass substrate 24. The measuring unit 158 has a plurality of spaced cameras 160 each comprising a CCD or the like. As shown in FIG. 27, the measuring unit 158 has four cameras 160, for example, for capturing the images of four corners K1 through K4 of a glass substrate 24 to which a photosensitive resin layer 28 is attached. Alternatively, the measuring unit 158 may have at least two cameras for capturing the images of each of longitudinal and transverse sides of a glass substrate 24, rather than the four corners K1 through K4 thereof.

The measuring unit 158 may comprise color sensors or laser sensors for detecting end faces of a glass substrate 24 or may comprise a combination of LED sensors, photodiode sensors, or line sensors for detecting end faces of a glass substrate 24. At least two of these sensors should desirably be employed to capture the image of each of the end faces for detecting the linearity of each of the end faces.

Surface inspection units (not shown) may be employed to detect surface defects of photosensitive laminated bodies 106, such as surface irregularities caused by the photosensitive web 22 itself, laminated film density irregularities caused by the manufacturing facility, wrinkles, striped patterns, dust particles, and other foreign matter. When such a surface defect is detected, the manufacturing apparatus 140 issues an alarm, ejects defective products, and manages subsequent processes based on the detected surface defect.

According to the third embodiment, the attached substrate 24a to which the photosensitive web 22 is laminated is cooled by the cooling mechanism 122 and then delivered to the prepeeler 144. In the prepeeler 144, the nip roller assemblies 152, 154 grip the trailing and leading ends of two adjacent glass substrates 24, and the nip roller assembly 152 moves in the direction indicated by the arrow C at the same speed as the glass substrates 24, with the nip roller assembly 154 being decelerated in its travel in the direction indicated by the arrow C.

Consequently, as shown in FIG. 26, the photosensitive web 22 between the glass substrates 24 are flexed between the nip roller assemblies 152, 154. Then, the peeling bar 156 is lifted to push the photosensitive web 22 upwardly, peeling the projecting films 30 off from the trailing and leading ends of the two adjacent glass substrates 24.

In the automatic base peeling mechanism 142, the takeup roll 148 is rotated to continuously wind the base film 26 from the attached substrate 24a. After the photosensitive web 22 is cut off in case of trouble and separated to discharge defective sections, a leading end of the base film 26 on an attached substrate 24a to which the photosensitive web 22 starts being laminated and the trailing end of the base film 26 wound on the takeup roll 148 are automatically attached to each other by the automatic attaching unit 150.

The glass substrate 24 from which the base film 26 is peeled off is placed in an inspecting station combined with the measuring unit 158. In the inspecting station, the glass substrate 24 is fixed in place, and the four cameras 160 capture the images of the glass substrate 24 and the photosensitive resin layer 28. The captured images are processed to determine applied positions a through d.

In the inspecting station, the glass substrate 24 may be fed along without being stopped, and transverse ends of the glass substrate 24 may be detected by cameras or image scanning; and longitudinal ends thereof may be detected by timing sensors. Then, the glass substrate 24 may be measured based on the detected data produced by the cameras or image scanning and the sensors.

According to the third embodiment, after the photosensitive web 22 has been laminated onto a glass substrate 24, the photosensitive web 22 between two adjacent attached substrates 24a is not cut off. Rather, while the attached substrates 24a are being pressed by the peeling roller 146, the base film 26 is continuously peeled off from the attached substrates 24a and wound around the takeup roll 148 which is in rotation. Also, the peeled base film 26 is easily processed.

According to the third embodiment, the same advantages as those of the second embodiment are achieved, e.g., the photosensitive laminated body 106 can be manufactured automatically and efficiently. Furthermore, the manufacturing apparatus 140 is simple in structure.

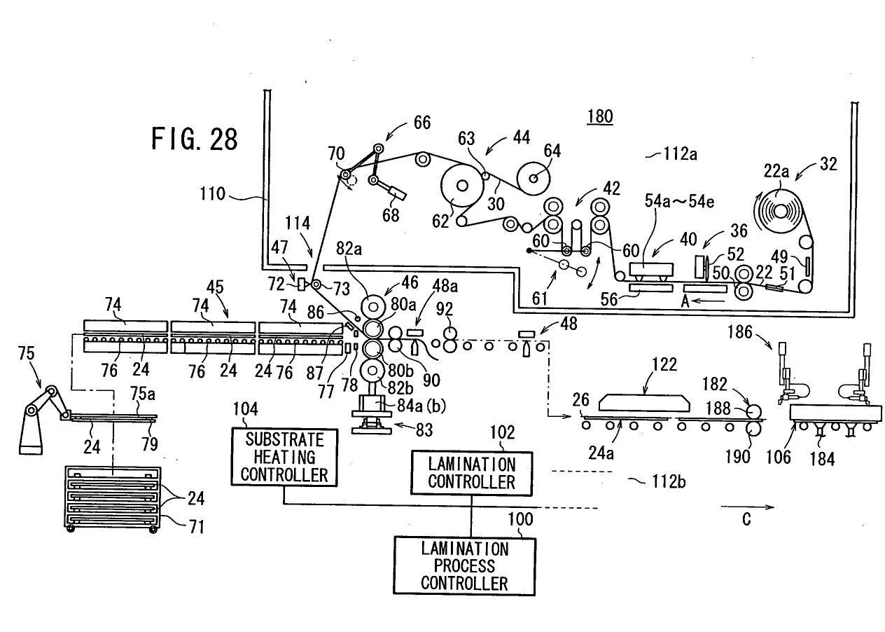

FIG. 28 is a schematic side elevational view of a manufacturing apparatus 180 according to a fourth embodiment of the present invention.

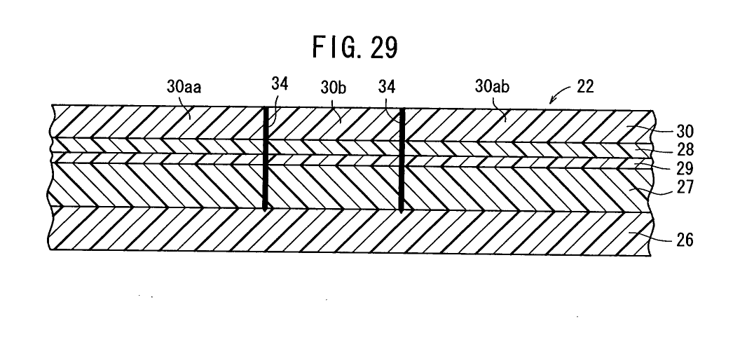

As shown in FIG. 29, the photosensitive web 22 that is used in the manufacturing apparatus 180 is a laminate made up from a base film 26, a cushion layer (thermoplastic resin layer) 27, an intermediate layer (oxygen barrier film) 29, a photosensitive resin layer 28, and a protective film 30.

The base film 26 is formed from polyethylene-telephthalate (PET), the cushion layer 27 is formed from an ethylene and oxidized-vinyl copolymer, the intermediate layer 29 is formed from polyvinyl alcohol, the photosensitive resin layer 28 is formed from a color photosensitive resin composition containing an alkaline soluble binder, a monomer, a photo-polymerizing initiator, and a coloring agent, and the protective film 30 is formed from polypropylene.

The manufacturing apparatus 180 comprises, at a position downstream from the inter-substrate web cutting mechanism 48, a cooling mechanism 122 for cooling an attached substrate 24a, i.e., a glass substrate 24 and the photosensitive web 22 attached thereto, from which the protective film 30 has been peeled off, a heating mechanism 182 for heating the resin layers, e.g., the cushion layer 27, inside of the aforementioned cooled attached substrate 24a, to within a predetermined temperature range (stated below), which is at or below the glass transition temperature (Tg), and a base peeling mechanism 186 for peeling the base film 26 away from the aforementioned attached substrate 24a, which is supported under suction by a plurality of suction pads 184, thereby producing the photosensitive laminated body 106.

The cooling mechanism 122 performs a cooling process by supplying a chilled air stream toward the attached substrate 24a. More specifically, such cooling is performed by setting a cooling temperature of 10° C. and a wind or air stream speed of 0.5 to 2.0 m/min. The heating mechanism 182 is equipped with a heating roller 188 arranged on the base film 26 side of the attached substrate 24a, and a receiving roller 190 arranged on the glass substrate 24 side opposite from the heating roller 188.

The heating roller 188 conducts internal and external heating in accordance with an electromagnetic induction heating method, and through direct contact with the base film 26 heats the cushion layer 27 from the base film 26 side. Instead of electromagnetic induction heating, a heating method using a sheathed heater, or a heated water (liquid) heating method may also be employed. Further, the heating roller 188 may be constructed from a rubber roller, a metal roller, a fabric wound roller, or a resin roller, or the like, while in addition, multiple rollers may be disposed along the direction of the arrow C.

It is unnecessary for the receiving roller 190 to be heated, and if deemed necessary, the receiving roller 190 may be constructed as a cooling roller having a cooling liquid circulated therein.

The heating roller 188 heats the cushion layer 27 to within a preset temperature range, which is at or below the glass transition temperature. In this case, for the glass transition temperature of the cushion layer 27, e.g., tan δ (loss coefficient) is detected by measuring viscoelasticity, and the glass transition temperature is obtained from the value at which tan δ becomes maximum.

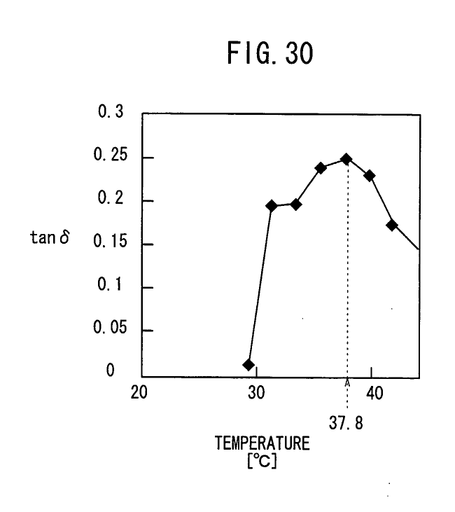

A viscoelasticity measurement device manufactured by Toyo Baldwin Co., Ltd. was used on the laminated body film for detecting the characteristics of temperature versus tan δ, whereby the results shown in FIG. 30 were obtained. From such results, the glass transition temperature of the cushion layer 27 was determined to be 37.8° C.

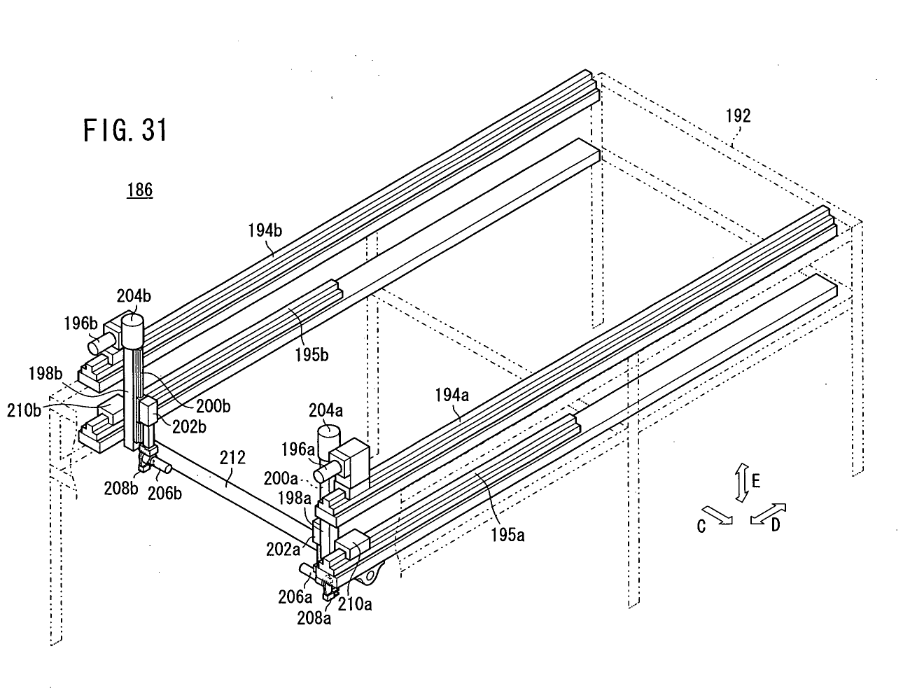

As shown in FIG. 31, the base peeling mechanism 186 is equipped with a frame member 192. In the frame member 192, upper guide rails 194a, 194b, which extend in the direction of the arrow D perpendicular to the feed direction (direction of arrow C) of the attached substrate 24a, extend mutually in parallel at a given fixed distance from each other. Beneath the upper guide rails 194a, 194b, shorter lower guide rails 195a, 195b extend similarly mutually in parallel in the direction of the arrow D. Mobile members 198a, 198b capable of reciprocating movement along the direction of the arrow D by means of motors 196a, 196b are supported on the upper guide rails 194a, 194b.

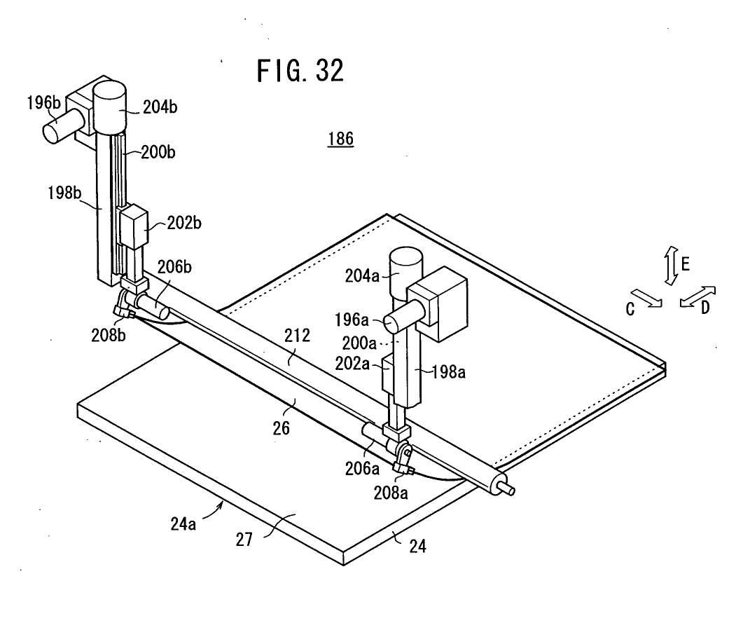

As shown in FIGS. 31 and 32, the mobile members 198a, 198b extend vertically (in the direction of arrow E), wherein vertically extending guide rails 200a, 200b are disposed along the mutually opposing faces thereof. Elevating platforms 202a, 202b are supported on the guide rails 200a, 200b, wherein the platforms 202a, 202b are elevated and lowered by means of motors 204a, 204b.

Rotating drive sources 206a, 206b are installed horizontally on the elevating platforms 202a, 202b. Chucks 208a, 208b are fixed to the rotation axes (not illustrated) of the rotating drive sources 206a, 206b. The chucks 208a, 208b are formed to be freely rotatable, and further, at a base film peeling position of the attached substrate 24a, are positionally adjustable so as to acquire positions for grasping both side portions of the base film 26, which project outward from both ends in the feed direction of the glass substrate 24 from which the aforementioned attached substrate 24a is constructed.

As shown in FIG. 31, slide bases 210a, 210b are supported on the lower guide rails 195a, 195b, and both ends of a profiling roller 212 are ascendably and descendably supported on the slide bases 210a, 210b. The slide bases 210a, 210b can be moved reciprocally within a fixed position interval integrally with the mobile members 198a, 198b in the direction of arrow D.

As shown in FIG. 28, according to the fourth embodiment, each of the attached substrates 24a which are separated by the inter-substrate web cutting mechanism 48 is fed to the cooling mechanism 122, and after being forcibly cooled, for example to room temperature (about 20° C.) under action of the supplied cooling air, is subsequently fed to the heating mechanism 182. In the heating mechanism 182, the attached substrate 24a is gripped between the heating roller 188 and the receiving roller 190, and direct heat transfer is conducted from the heating roller 188 to the base film 26 of the attached substrate 24a.

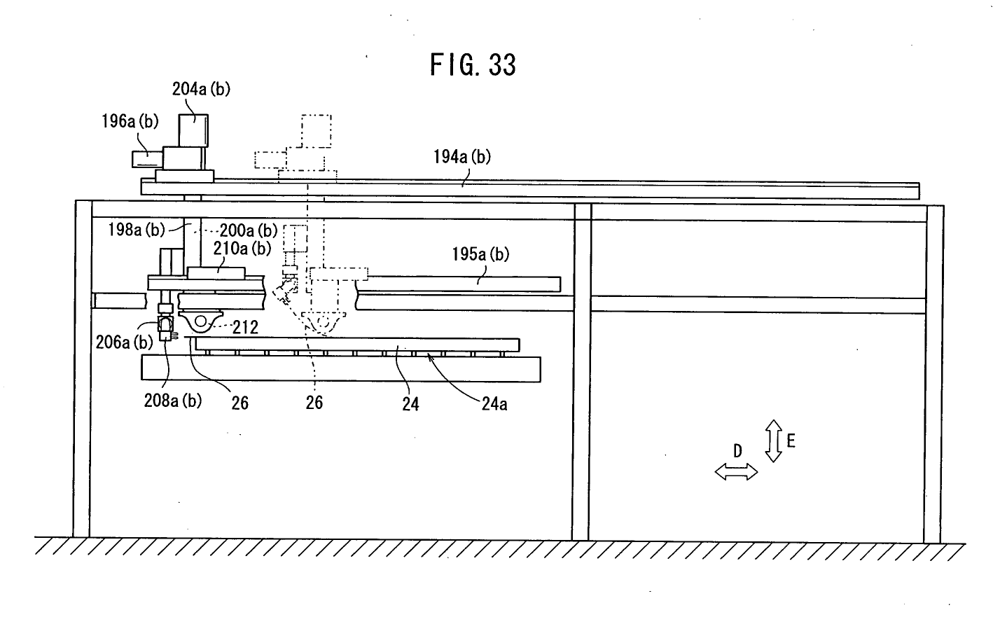

As a result, after the cushion layer 27 is heated to a predetermined temperature by the base film 26, the attached substrate 24a is delivered to the base peeling mechanism 186. In the base peeling mechanism 186, while the glass substrate 24 side of the attached substrate 24a is supported under a suction action of the suction pads 184, the chucks 208a, 208b are each arranged in the direction of arrow D toward one end side of the base film 26, which projects inwardly from both ends of the glass substrate 24 in the feed direction. (Refer to FIG. 33.)

Then, the mobile members 198a, 198b are moved toward the attached substrate 24a under action of the motors 196a, 196b and each of the chucks 208a, 208b is closed for gripping both end portions of the base film 26 in the feed direction. Further, the chucks 208a, 208b are rotated under action of the rotating drive sources 206a, 206b, while the elevating platforms 202a, 202b and mobile members 198a, 198b are controllably driven in a given direction.

As a result, as shown in FIGS. 32 and 33, the chucks 208a, 208b are moved along a fixed peeling trajectory, and the base film 26 which is gripped by the chucks 208a, 208b is separated from the cushion layer 27 and is peeled away from the attached substrate 24a. At this time, the profiling roller 212 is moved integrally with the mobile members 198a, 198b in the direction of arrow D until reaching a fixed position, whereby the base film 26 is smoothly and favorably peeled off. The photosensitive laminated body 106 is obtained as a result of peeling the base film 26 away from the attached substrate 24a.

In this case, according to the fourth embodiment, after the cushion layer 27 of the attached substrate 24a, which has been forcibly cooled through the cooling mechanism 122, is then heated to a temperature in the vicinity of the glass transition temperature from the side of the base film 26 under action of the heating mechanism 182, peeling of the base film 26 is performed through means of the base peeling mechanism 186.

More specifically, in the attachment mechanism 46, the photosensitive web 22 is attached by thermocompression to the glass substrate 24 under application of a fixed tension, wherein residual stresses are easily generated within the cushion layer 27. Furthermore, residual stresses are also generated in the cushion layer 27 because the attached substrate 24a is subjected to forcible cooling by the cooling mechanism 122. Accordingly, in this condition, when the base film 26 is peeled away from the attached substrate 24a, it is easy for the cushion layer 27 to become torn or otherwise damaged as a result of the residual stresses in the cushion layer 27. Therefore, defective regions such as dimples or cavities may be formed in the cushion layer 27, causing a lowering of product quality.

According to the fourth embodiment, before peeling of the base film 26, heating is performed from the side of the base film 26 up to a temperature in the vicinity of the glass transition temperature of the cushion layer 27, and as a result, residual stresses in the cushion layer 27 are mitigated.

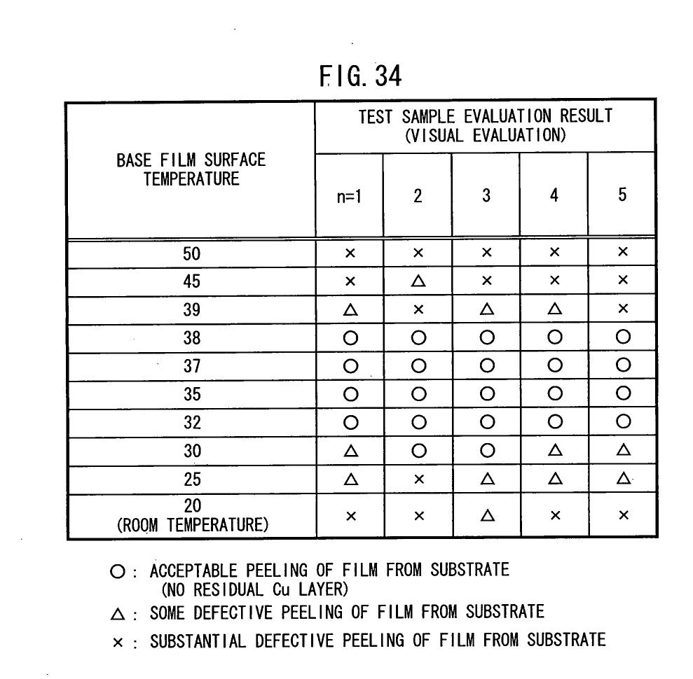

The surface temperature of the base film 26 was variously modified, and a test was performed in order to detect the presence of tearing defects during peeling of the base film 26. The results of this test are shown in FIG. 34. According to this test, favorable peeling processes were accomplished and high quality photosensitive laminated bodies 106 were obtained by setting the surface temperature of the base film 26 to within a temperature range of 32° C. to 38° C., corresponding to a fixed temperature range that is at or below the glass transition temperature (37.8° C.) of the cushion layer 27.

Furthermore, the heating mechanism 182 heats the attached substrate 24a from the base film 26 side thereof. Accordingly, in comparison to the case of heating from the glass substrate 24 side, since the peeling region between the base film 26 and the cushion layer 27 can be swiftly and reliably heated to the desired temperature, highly accurate peeling processing at the peeling region can be achieved.

In addition, the base peeling mechanism 186 is separated from the heating mechanism 182 by a fixed interval. Therefore, the attached substrate 24a, which has been once heated and within which residual stresses have been alleviated, is cooled while being transported to the base peeling mechanism 186.

Incidentally, the profiling roller 212, which makes up part of the base peeling mechanism 186, may also be heated through an unillustrated heating mechanism and brought into contact with the base film 26. As a result, the base film 26 may be peeled away from the cushion layer 27 while applying heat thereto. Further, the profiling roller 212 may also be arranged as a plurality of rollers.

In the fourth embodiment, the base peeling mechanism 186 is constructed so as to peel the base film 26 in the direction of arrow D, which intersects the feed direction (direction of arrow C) of the attached substrate 24a. However, the peeling direction of the base film 26 may also be set in the direction of arrow C, which is parallel to the feed direction of the attached substrate 24a.

Further, a pre-heating mechanism (not shown) may be installed at an upstream side of the heating mechanism 182 for performing supplemental heating of the attached substrate 24a. For example, an infrared power heater comprising a coil, carbon or halogen source, or a ceramic IR heater, or other of various contact type heating rollers, may be employed as the pre-heating mechanism.

In addition, in the fourth embodiment, the manufacturing apparatus 20 basically in accordance with the first embodiment is employed. However, the invention is not limited in this manner, and the features of this embodiment may also be applied to the manufacturing apparatuses 120, 140 according to the second and third embodiments.

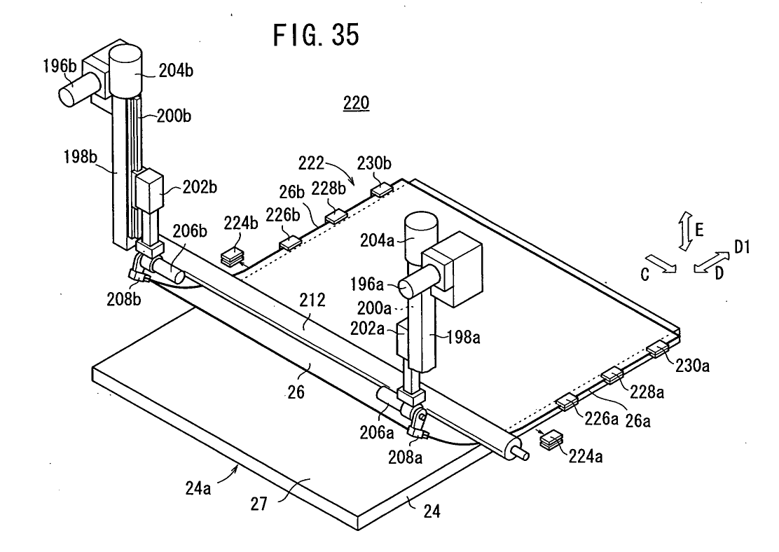

FIG. 35 is a schematic perspective view of a base peeling mechanism 220, making up the manufacturing apparatus in accordance with a fifth embodiment of the present invention. Structural elements thereof, which are the same as those of the base peeling mechanism 186 making up the manufacturing apparatus 180 according to the fourth embodiment are designated by like reference numerals and detailed explanations thereof shall be omitted.

The base peeling mechanism 220 comprises a tension applying structure 222, for applying tension to the base film 26 in the attachment direction thereof (direction of arrow C) with the glass substrate 24, when the base film 26 is peeled from the attached substrate 24a.

The tension applying structure 222 comprises movable chuck members 224a, 226a, 228a, 230a, capable of gripping an end portion 26a of the base film 26 that projects outwardly from a transport direction front end side of the attached substrate 24a, and movable chuck members 224b, 226b, 228b, 230b, capable of gripping a trailing end portion 26b of the base film 26 that projects toward a transport direction rear end side of the attached substrate 24a.

The chuck members 224a, 224b mutually face one another in the direction of arrow C, and the other chuck members 226a, 226b, 228a, 228b and 230a, 230b are arranged respectively mutually facing each other in the direction of the arrow C. The chuck members 224a to 230a and 224b to 230b are respectively openable and closable, and further, are movable toward and away from the base film 26.

In the fifth embodiment, when the attached substrate 24a is arranged in the base peeling position, the chuck members 224a to 230a which make up the tension applying structure 222 grip the front end portion 26a of the base film 26, and the chuck members 224b to 230b grip the rear end portion 26b of the base film 26. In this condition, a fixed tension is applied to the base film in the direction of arrow C, due to a torque control in a direction for mutually separating the chuck members 224a to 230a and the chuck members 224b to 230b.

Consequently, the chucks 208a, 208b grip the front end portion 26a and the rear end portion 26b of the base film 26, and move in the direction of arrow D1 along a preset peeling trajectory. At this time, a fixed tension is applied to the base film 26 in the direction of arrow C, so that the base film 26 can be smoothly and reliably peeled away from the glass substrate 24.

In addition, as the profiling roller 212 moves in the direction of arrow D1 and approaches the chuck members 224a, 224b, after releasing the gripping actions on the front end portion 26a and the rear end portion 26b of the base film 26, the chuck members 224a, 224b are moved in directions to mutually separate away from each other (i.e., in the directions of the arrows). Therefore, the chuck members 224a, 224b do not interfere with the profiling roller 212. As the profiling roller 212 continues to move in the direction of the arrow D1, the chuck members 226a, 226b separate away from the base film 26, and in succession, the chuck members 228a, 228b, and then the chuck members 230a, 230b separate away from the base film 26, whereupon the pealing operation of the base film 26 is completed.

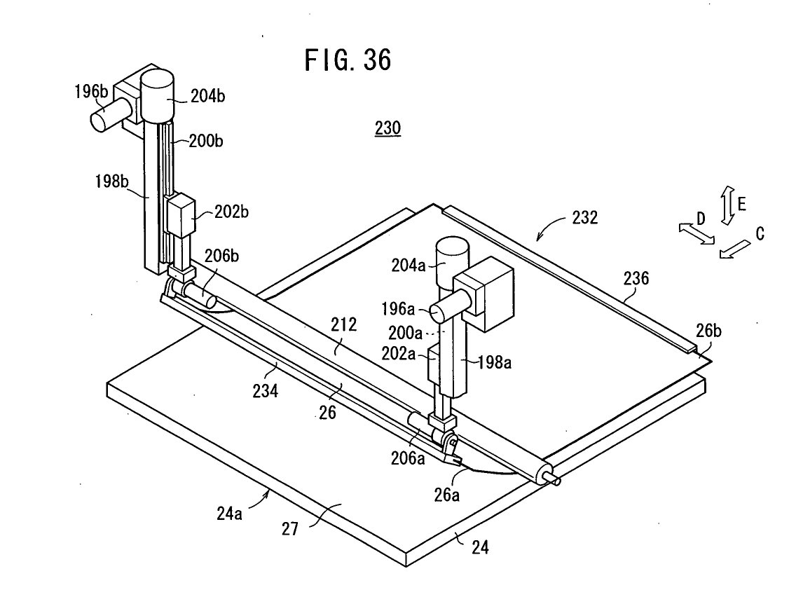

FIG. 36 is a schematic perspective view of a base peeling mechanism 230, making up the manufacturing apparatus in accordance with a sixth embodiment of the present invention.

The base peeling mechanism 230 is equipped with a tension applying mechanism 232 for applying tension to the base film 26 in an attachment direction thereof with the attached substrate 24a, when the base film 26 is peeled away from the attached substrate 24a.

The tension applying mechanism 232 comprises a front end chuck 234, which is capable of gripping a front end portion 26a of the base film 26 that projects toward a feed direction front end side of the attached substrate 24a, and a rear end chuck 236, which is capable of gripping a rear end portion 26b of the base film 26 that projects rearwardly of the feed direction of the attached substrate 24a. The front end chuck 234 and the rear end chuck 236 are widely formed in the direction of the arrow D, for gripping substantially the entire width dimension of the front end portion 26a and the rear end portion 26b of the base film 26, respectively.

The front end chuck 234 is installed to the rotating drive sources 206a, 206b, whereas other parts of the structure are formed in the same manner as the base peeling mechanism 186 of the fourth embodiment. In this case, the movement direction of the front end chuck 234 is set in the direction of arrow C, which is perpendicular to the movement direction (direction of arrow D) of the chucks 208a, 208b.

In the sixth embodiment, when the attached substrate 24a is fed to the base peeling position, the front end portion 26a of the base film, which projects toward the front end side of the attached substrate 24a, is gripped by the front end chuck 234. On the other hand, the rear end portion 26b of the base film 26, which projects toward the rear end side of the attached substrate 24a, is gripped by the rear end chuck 236.

Next, the rear end chuck 236, or the rear end chuck 236 and the front end chuck 234, are subjected to torque control, wherein tension is applied to the base film 26 gripped thereby along the direction of arrow C. In this condition, the base film 26 to which a predetermined tension is applied is smoothly and reliably peeled away from the glass substrate 24, by moving the front end chuck 234 along a preset peeling trajectory.

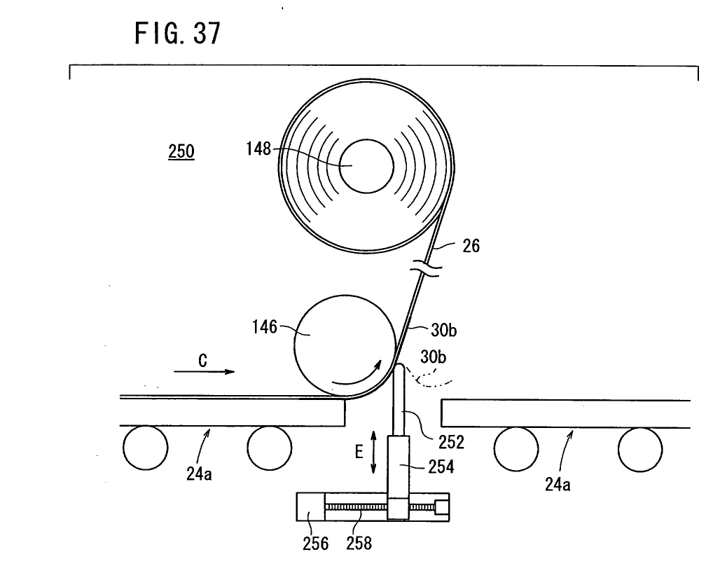

FIG. 37 is a schematic view of an automatic base peeling mechanism 250, making up the manufacturing apparatus in accordance with a seventh embodiment of the present invention. Structural elements thereof, which are the same as those of the base automatic peeling mechanism 142 making up the manufacturing apparatus 140 according to the third embodiment are designated by like reference numerals, and detailed explanations thereof shall be omitted.

The automatic base peeling mechanism 250 is equipped with a peeling bar (peeling guide member) 252 that guides the base film 26 along an outer circumference of the peeling roller 146 while moving between the attached substrates 24a. The peeling bar 252 is capable of advancing and retracting vertically (in the direction of arrow E) under the action of a cylinder 254. A ball screw 258 connected to a motor 256 is screw-engaged with the cylinder 254, for reciprocal movement in the direction of the arrow C. It is preferable for the peeling roller 146 to be heated by a non-illustrated heat source.

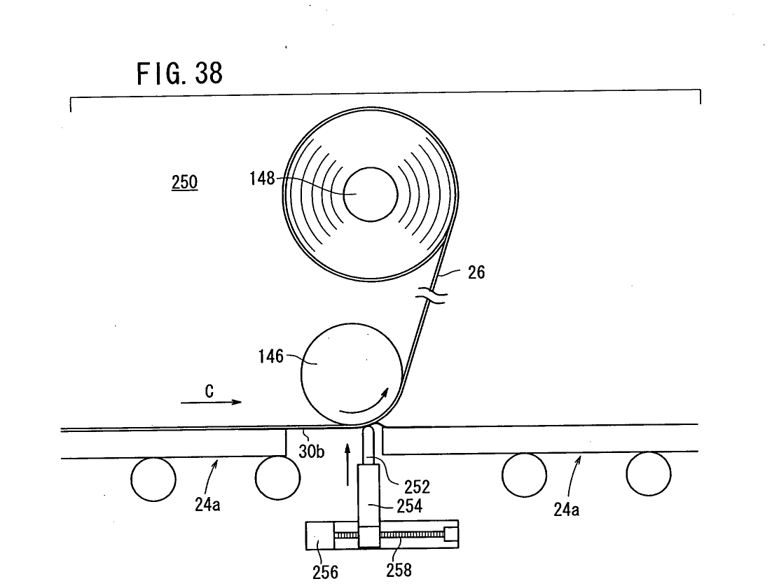

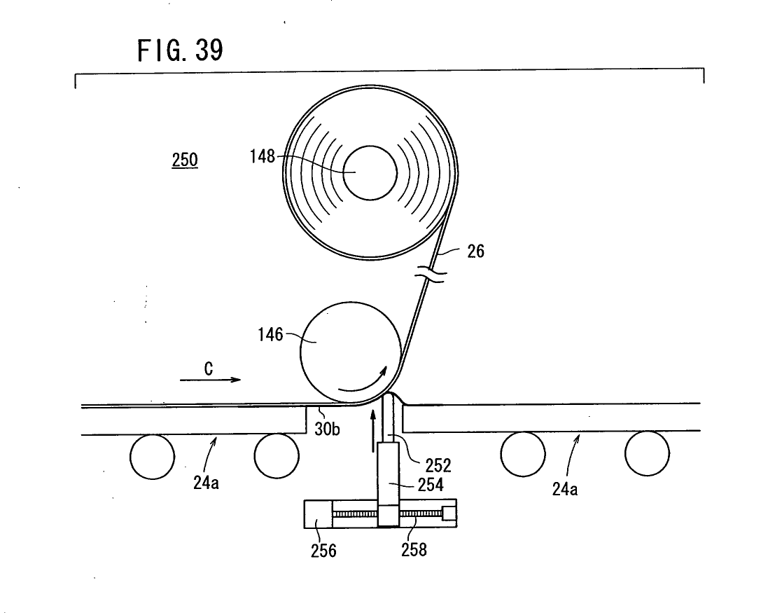

According to the seventh embodiment, as shown in FIG. 38, when the peeling bar 252 is positioned between respective attached substrates 24a, the peeling bar 252 projects upwardly under an action of the cylinder 254, for pressing the base film 26 from a residual section 30b side on the outer circumferential surface of the peeling roller 146. Further, the ball screw 258 is rotated under an action of the motor 256, and the cylinder 254 is moved in the direction of the arrow C, whereby the peeling bar 252 is pressed against the peeling roller 146 through means of the cylinder 254 (see, FIG. 39).

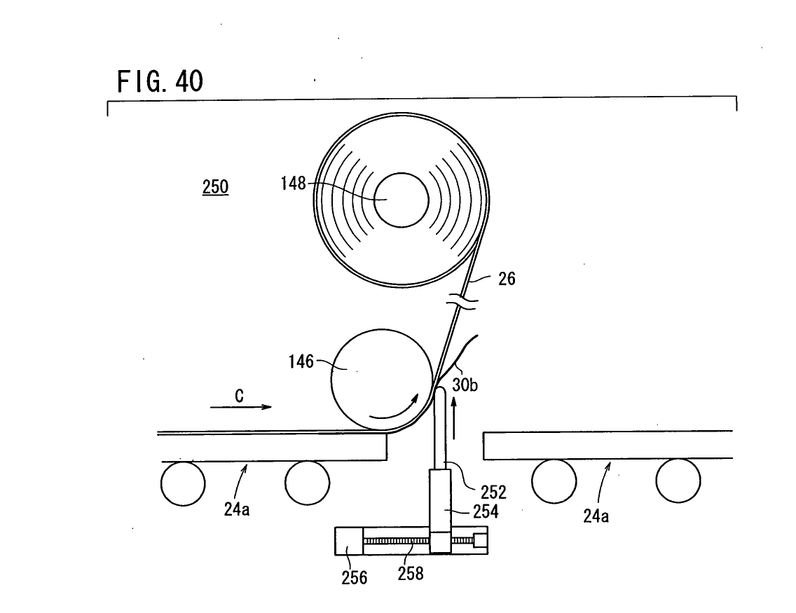

As a result, the peeling bar 252 guides the residual section 30b along the outer circumferential surface of the peeling roller 146. Accordingly, as shown in FIG. 40, due to the peeling bar 252 moving up to a fixed position on the outer circumference of the peeling roller 146, the residual section 30b is reliably peeled away from the rear end portion of the forwardly-advancing attached substrate 24a and is integrally wound up with the base film 26. Therefore, when the base film 26 is peeled away from the attached substrate 24a, the residual section 30b does not remain on the attached substrate 24a, and favorable automated peeling processing can be accomplished.

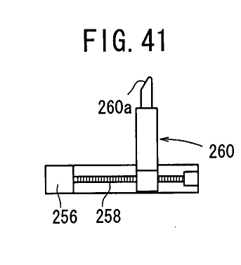

Furthermore, the peeling bar 252 is formed with a spherically shaped tip; however, the invention is not limited to this structure. For example, as shown in FIG. 41, a peeling bar 260 having a tapered tip portion 260a, with a tapered surface on the peeling roller 146 side thereof, may also be used.

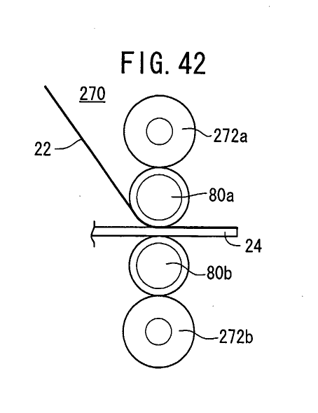

FIG. 42 is a frontal view showing an attachment mechanism 270 making up the manufacturing apparatus in accordance with an eighth embodiment of the present invention.

The attachment mechanism 270 comprises rubber rollers 80a, 80b and backup rollers 272a, 272b, wherein an outer circumference of the backup rollers 272a, 272b are configured to have a crown shape. Further, at least one of the backup rollers 272a, 272b and/or at least one of the rubber rollers 80a, 80b may be formed as a crown roller.

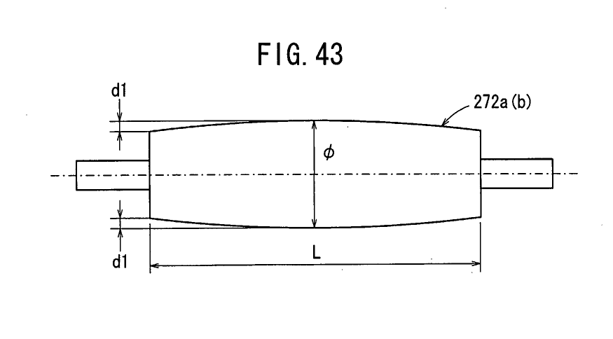

The crown shape may be a sine curve, a quadratic curve or a quartic curve. For example, as shown in FIG. 43, the roller surface length L=1000 mm to 3000 mm, the roll diameter φ=200 mm to 300 m, the crown rate d (=2d1)=0.1 mm to 3.0 mm, and the laminate linear pressure is 100 N/cm to 200 N/cm.

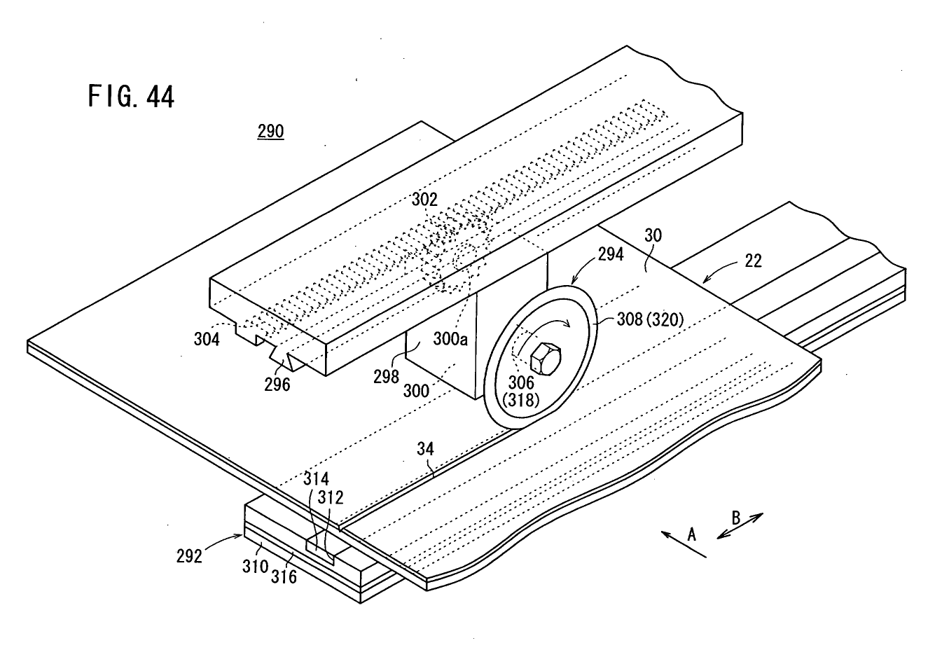

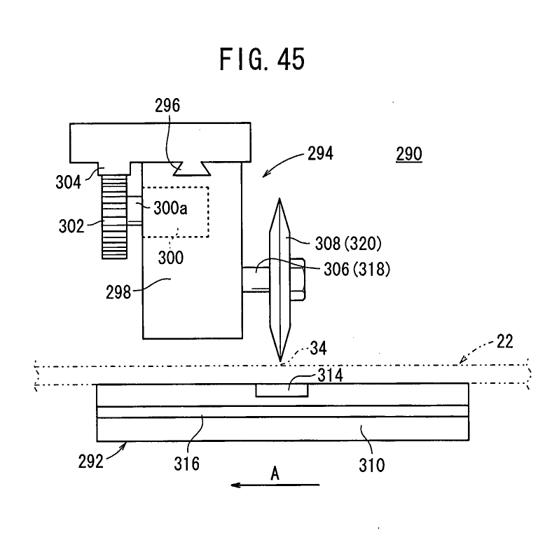

FIG. 44 is a schematic perspective view of a processing mechanism 290 making up the manufacturing apparatus in accordance with a ninth embodiment of the present invention. FIG. 45 is a schematic side elevational view of the processing mechanism 290.

The processing mechanism 290 comprises a heating mechanism 292 for heating partially cut regions 34 in the photosensitive web 22 to a predetermined temperature (discussed later), and a cutting mechanism 294 for making partial cuts along the partially cut regions 34 that have been heated to the predetermined temperature.

The cutting mechanism 294 comprises a linear guide 296 extending in the direction of arrow B perpendicular to the feed direction (direction of arrow A) of the photosensitive web 22, wherein a slide table 298 is supported on the linear guide 296. A motor 300 is installed inside of the slide table 298, and a pinion 302 is axially fitted to the rotational axis 300a of the motor 300. A rack 304, which engages with the pinion 302, extends in the direction of arrow B along the linear guide 296, wherein the slide table 298 is reciprocally movable in the direction of arrow B under the action of the motor 300.

A rotational axis 306 is disposed in the slide table 298, which projects from an opposite side of the side on which the pinion 302 is disposed. A rotating circular blade (cutter) 308 is integrally installed to the rotational axis 306. At a position opposite to the rotating circular blade 308, a cutting table 310 is disposed, with the photosensitive web 22 sandwiched therebetween.

The cutting table 310 comprises a two-ply metal plate structure, and extends in the direction of the arrow B. A concave groove 312 is formed in the upper surface of the cutting table 310 so as to extend along a movement range of the rotating circular blade 308 in the direction of arrow B, wherein the concave groove 312 accommodates a resin-made receiving portion 314 therein.

The heating mechanism 292 is embedded in the cutting table 310, and more specifically, comprises a sheet type heater 316 sandwiched between the two metal plates. The cutting table 310 serves as a heating member for directly heating a partially cut region 34 of photosensitive web 22 that contacts the cutting table 310. The sheet type heater 316 may also be arranged between the concave groove 312 and the receiving portion 314.

In place of the rotating circular blade 308, a fixed circular blade 320, which is fixed to a fixed axis 318 that extends from the slide table 298, may also be used. Such a fixed circular blade 320 may be adjustable at each of respective angular positions forming preset angles with respect to the fixed axis 318.

The partially cut region 34 is provided for cutting (severing) at least the protective film 30, and in actuality, the cutting depth of the rotating circular blade 308 (or the fixed circular blade 320) is set in order to reliably sever the protective film 30. In the partially cut region 34, a cutting method using ultrasonic waves, or any of methods formed by a knife blade, a band-shaped push cutting blade (Thomson Blade), or the like, may be used in place of the rotating circular blade 308 (or the fixed circular blade 320). The push cutting blade may include a slanted push cutting structure, in addition to a vertical push cutting-structure.

In the ninth embodiment, the sheet heater 316 forming the heating mechanism 292 is activated, wherein the cutting table 310 comprising the sheet heater 316 therein is heated to a preset desired temperature. As a result, the photosensitive web 22 fed in the direction of arrow A contacts the cutting table 310, which moves simultaneously with the photosensitive web 22, and is directly heated thereby, and while the partially cut region 34 is heated to a predetermined fixed temperature corresponding to the rotating circular blade 308, a partial cut is made via the cutting mechanism 294. It is also acceptable for the partial cut to be made while the photosensitive web 22 is in a stationary condition.

Specifically, when the pinion 302 is rotated under a driving action of the motor 300 disposed in the slide table 298, under an engagement action of the pinion 302 and rack 304, the slide table 298 is supported by the linear guide 296 and moves in the direction of arrow B. Consequently, the rotating circular blade 308 rotates while moving in the direction of arrow B, under a state in which the blade cuts into the partially cut region 34 of the photosensitive web 22 at a desired depth. As a result, a partially cut region 34 of a desired cutting depth from the protective film 30 is formed in the photosensitive web 22.

In this case, the partially cut region 34 is partially cut by the cutting mechanism 294, while the partially cut region 34 of the photosensitive web 22 is heated via the heating mechanism 292. At this time, generation of cutting debris or interlaminar peeling (delamination) can be effectively prevented, as a result of setting the heating temperature of the photosensitive web 22 for each of the rotating circular blades 308 or the fixed circular blades 320.

In the above-described ninth embodiment, a concave groove 312 is formed in the cutting table 310 and a receiving portion 314 is accommodated inside the concave groove 312. However, it is also acceptable to provide a resin receiving film on an upper surface of the cutting table without forming any concave groove therein. Further, in place of a sheet heater 316, it is acceptable to use a sheathed heater or a tubular type heater. Still further, a heating box, accommodating the cutting mechanism 294 and the partially cut region 34 therein may be provided, wherein heated air is supplied to the interior of the heating box. Furthermore, it is also acceptable to provide a heating plate, a bar heater, or a heating box or the like upstream of the cutting mechanism 294, in order to heat the photosensitive web 22 before making the partial cut therein.

Although certain preferred embodiments of the present invention have been shown and described in detail, it should be understood that various changes and modifications may be made therein without departing from the scope of the appended claims.

1. An apparatus for manufacturing a photosensitive laminated body, comprising:
a web reel-out mechanism for reeling out an elongate photosensitive web comprising a support, a photosensitive material layer disposed on said support, and a protective film disposed on said photosensitive material layer, said protective film having a peel-off section and a residual section;
a processing mechanism for forming a processed region which is transversely severable in said protective film of said elongate photosensitive web which has been reeled out by said web reel-out mechanism, at a boundary position between said peel-off section and said residual section;
a peeling mechanism for peeling said peel-off section off from said elongate photosensitive web, leaving said residual section;
a substrate feed mechanism for feeding a substrate which has been heated to a predetermined temperature to an attachment position;
an attachment mechanism for positioning said residual section between said substrates and attaching an exposed area of said photosensitive material layer from which said peel-off section has been peeled off to said substrate in said attachment position, thereby producing an attached substrate;
a support peeling mechanism positioned downstream from said attachment mechanism for peeling off said support from said attached substrate
a cooling mechanism positioned between said attachment mechanism and said support peeling mechanism, for cooling said attached substrate; and
a heating mechanism for heating a resin layer, which is laminated on said support, within a predetermined temperature range which is at or below the glass transition temperature.

2. The apparatus according to claim 1, wherein said support peeling mechanism comprises a tension applying structure for applying tension to said support along the attachment direction with said substrate when peeling off said support.

3. The apparatus according to claim 1, wherein said support peeling mechanism comprises a peeling roller for peeling said support from said substrate following an outer circumferential portion thereof, and a peeling guide member for guiding said support along an outer circumference of said peeling roller while moving between said substrates.

4. The apparatus according to claim 1, wherein said attachment mechanism comprises:
a pair of rubber rollers which are heated to a predetermined temperature; and
a pair of backup rollers in sliding contact with said pair of rubber rollers
wherein outer circumferential surfaces of at least one of said rubber rollers and/or at least one of said backup rollers is set with a crown shape.

5. An apparatus for manufacturing a photosensitive laminated body, comprising:
a web reel-out mechanism for reeling out an elongate photosensitive web comprising a support, a photosensitive material layer disposed on said support, and a protective film disposed on said photosensitive material layer, said protective film having a peel-off section, and a residual section;
a processing mechanism for forming a partially cut region which is transversely severable in said protective film of said elongate photosensitive web which has been reeled out by said web reel-out mechanism, at a boundary position between said peel-off section and said residual section;
a peeling mechanism for peeling said peel-off section off from said elongate photosensitive web, leaving said residual section;
a substrate feed mechanism for feeding a substrate which has been heated to a predetermined temperature to an attachment position;
an attachment mechanism for positioning said residual section between said substrates and attaching an exposed area of said photosensitive material layer from which said peel-off section has been peeled off to said substrate in said attachment position, thereby producing an attached substrate; and
a support peeling mechanism positioned downstream from the attachment mechanism for peeling off said support from said attached substrate,
wherein said processing mechanism comprises:
a cutter for forming said partially cut region in said elongate photosensitive web; and
a heater for heating said partially cut region at the time of making the partial cut to a predetermined temperature corresponding to said cutter.

6. A method of manufacturing a photosensitive laminated body, comprising the steps of:
reeling out an elongate photosensitive web each comprising a support, a photosensitive material layer disposed on said support, and a protective film disposed on said photosensitive material layer, said protective film having a peel-off section and a residual section;
forming a processed region which is transversely severable in said protective film of said elongate photosensitive web which has been reeled out, at a boundary position between said peel-off section and said residual section;
peeling said peel-off section (30aa) off from said elongate photosensitive web, leaving said residual section;
feeding a substrate which has been heated to a predetermined temperature to an attachment position;
positioning said residual section between said substrates and attaching an exposed area of said photosensitive material layer from which said peel-off section has been peeled off to said substrate in said attachment position, thereby producing an attached substrate;
cooling said attached substrate at position downstream from said attachment position; and
heating a resin layer, which is laminated on said support, within a predetermined temperature range which is at or below the glass transition temperature.

7. The method according to claim 6, further comprising the steps of:
peeling each support from said attached substrate and obtaining a photosensitive laminated body, after severing said elongate photosensitive web between said attached substrates downstream from said attachment position; and
applying tension to said support along the attachment direction with said substrate when said support is peeled.

8. The method according to claim 7, further comprising the steps of:
peeling said support from said substrate following an outer circumferential portion of a peeling roller; and
guiding said support along an outer circumference of said peeling roller while a peeling guide member moves between said substrates.

9. A method of manufacturing a photosensitive laminated body, comprising the steps of:
reeling out an elongate photosensitive web comprising a support, a photosensitive material layer disposed on said support, and a protective film disposed on said photosensitive material layer, said protective film having a peel-off section and a residual section;
making a partial cut in said elongate photosensitive web while heating a partially cut region to a predetermined temperature corresponding to a cutter which is transversely severable in said protective film of said elongate photosensitive web which had been reeled out, at a boundary position between said peel-off section and said residual section;
peeling said peel-off section off from said elongate photosensitive web, leaving said residual section;
feeding a substrate which has been heated to a predetermined temperature to an attachment position;
positioning said residual section between said substrates and attaching an exposed area of said photosensitive material layer from which said peel-off section has been peeled off to said substrate in said attachment position, thereby producing an attached substrate; and
preheating said elongate photosensitive web to a predetermined temperature at a vicinity upstream of said attachment position.
